(19) United States
(12) Patent Application Publication
(10) Pub. No.: US 2026/0158784 A1
(43) Pub. Date: Jun. 11, 2026

(54) MANUFACTURING METHOD OF LIQUID EJECTION HEAD

(71) Applicant: SEIKO EPSON CORPORATION, Tokyo (JP)

(72) Inventor: Atsushi MUTO, SHIOJIRI-SHI (JP)

(21) Appl. No.: 19/178,986

(22) Filed: Apr. 15, 2025

(30) Foreign Application Priority Data
Apr. 17, 2024 (JP) 2024-066585

(51) Int. Cl. B41J 2/16

(52) U.S. Cl. CPC B41J 2/1623; B41J 2/161; B41J 2202/19; B41J 2202/22

(57) ABSTRACT

A manufacturing method of a liquid ejection head is a method for reusing a first head chip of a first liquid ejection head to manufacture a second liquid ejection head including a second head chip, the first head chip and the second head chip each including an actuator that is driven for liquid ejection, the manufacturing method including: a removal step of removing the first head chip from the first liquid ejection head; an assembly step of incorporating the first head chip into the second liquid ejection head; and an adjustment step of performing an adjustment process of reducing a difference between ejection performance of the first head chip and ejection performance of the second head chip, on the actuator of at least one of the first head chip or the second head chip.

The present application is based on, and claims priority from JP Application Serial Number 2024-066585, filed Apr. 17, 2024, the disclosure of which is hereby incorporated by reference herein in its entirety.

### BACKGROUND

### 1. Technical Field

The present disclosure relates to a manufacturing method of a liquid ejection head.

### 2. Related Art

An apparatus including a liquid ejection head equipped with a plurality of head chips that eject liquid such as ink is known (for example, see JP-A-2015-39804).

In such a related art, when the liquid ejection head included in the apparatus that ejects liquid fails or reaches the end of its life due to deterioration caused by use, the apparatus is repaired by replacing the liquid ejection head. One liquid ejection head is equipped with a plurality of head chips. Therefore, when the appearance of deterioration or failure is different for each head chip, but it is determined that some head chips are unusable or close to the end of life, each liquid ejection head is replaced, and there is a problem that even a head chip that can be used or a head chip with a low degree of deterioration is discarded. Therefore, it is desired to recycle the liquid ejection head by reusing the used head chips that can be used, but, when the degree of deterioration of a plurality of used head chips incorporated in the recycled liquid ejection head varies, the ejection performance varies. Therefore, when the liquid ejected from the liquid ejection head is, for example, an ink, there is a concern that a quality of an image formed by the ink deteriorates.

### SUMMARY

The present disclosure can be implemented as the following aspects or application examples. The present disclosure is a manufacturing method of a liquid ejection head that is a method for reusing a first head chip of a first liquid ejection head to manufacture a second liquid ejection head including the first head chip and a second head chip different from a head chip incorporated in the first liquid ejection head, the first head chip and the second head chip each including an actuator that is driven for liquid ejection, the manufacturing method including: a removal step of removing the first head chip from the first liquid ejection head; an assembly step of incorporating the first head chip into the second liquid ejection head; and an adjustment step of performing an adjustment process of reducing a difference between ejection performance of the first head chip and ejection performance of the second head chip, on the actuator of at least one of the first head chip or the second head chip.

### BRIEF DESCRIPTION OF THE DRAWINGS

FIG. 1 is a top view illustrating a schematic configuration of a liquid ejection apparatus used in a manufacturing method of a liquid ejection head according to an embodiment.

FIG. 2 is a side view illustrating the schematic configuration of the liquid ejection apparatus.

FIG. 3 is an exploded perspective view illustrating a structure of a head unit.

FIG. 4 is an exploded perspective view illustrating a liquid ejection head.

FIG. 5 is a cross-sectional view of a head chip included in the liquid ejection head.

FIG. 6 is an explanatory view illustrating a functional configuration of the liquid ejection apparatus.

FIG. 7 is an explanatory view illustrating a drive signal.

FIG. 8 is an explanatory view schematically illustrating a transition until the head chip incorporated in the head unit is collected and reused.

FIG. 9 is an explanatory view schematically illustrating an initial characteristic value of the head chip and a subsequent temporal change.

FIG. 10 is a process view illustrating a manufacturing process of a liquid ejection head according to a first embodiment.

FIG. 11 is an explanatory view illustrating an aspect of coupling between a relay substrate and a reading device of the head unit.

FIG. 12 is an explanatory view schematically illustrating an aspect of a manufacturing process according to the first embodiment.

FIG. 13 is an explanatory view illustrating that characteristics of piezoelectric actuators having different ejection performance change due to aging.

FIG. 14 is an explanatory view schematically illustrating a case in which a new head chip is used in the manufacturing process according to the first embodiment.

FIG. 15 is a process view illustrating a manufacturing process of a liquid ejection head according to a second embodiment.

FIG. 16 is an explanatory view schematically illustrating an aspect of a manufacturing process according to the second embodiment.

FIG. 17 is an explanatory view schematically illustrating an example of a priority of ranking.

FIG. 18 is a process view illustrating a manufacturing process of a liquid ejection head according to a third embodiment.

FIG. 19 is an explanatory view schematically illustrating an aspect of the manufacturing process according to the third embodiment.

### DESCRIPTION OF EMBODIMENTS

Hereinafter, embodiments of a manufacturing method of a liquid ejection head will be described with reference to the drawings. The drawings to be used are for convenience of description. The following embodiments are merely examples of the embodiments, and do not limit the contents of the present disclosure. Further, the following configurations should not be interpreted as being essential, except for a configuration described as an essential configuration.

### A. First Embodiment

### A1. Overview of Liquid Ejection Apparatus

A manufacturing method of a liquid ejection head according to a first embodiment will be described below. The manufacturing method according to the first embodiment is a method for reusing a first head chip of a first liquid ejection head to manufacture a second liquid ejection head including the first head chip and a second head chip different from a head chip incorporated in the first liquid ejection head. Therefore, before describing the manufacturing method of the liquid ejection head, configurations of a head unit including a plurality of liquid ejection heads 31 corresponding to the first liquid ejection head, and a liquid ejection apparatus including the head unit will be described. In the present specification, sending out a liquid from a nozzle or the like to the outside is referred to as “ejection”. The ejection includes various aspects in which a predetermined amount of liquid is output to the outside, such as ejection, jetting, spraying, discharge, and intermittent outflow, regardless of a type of liquid, an output time, the number of times, and the like.

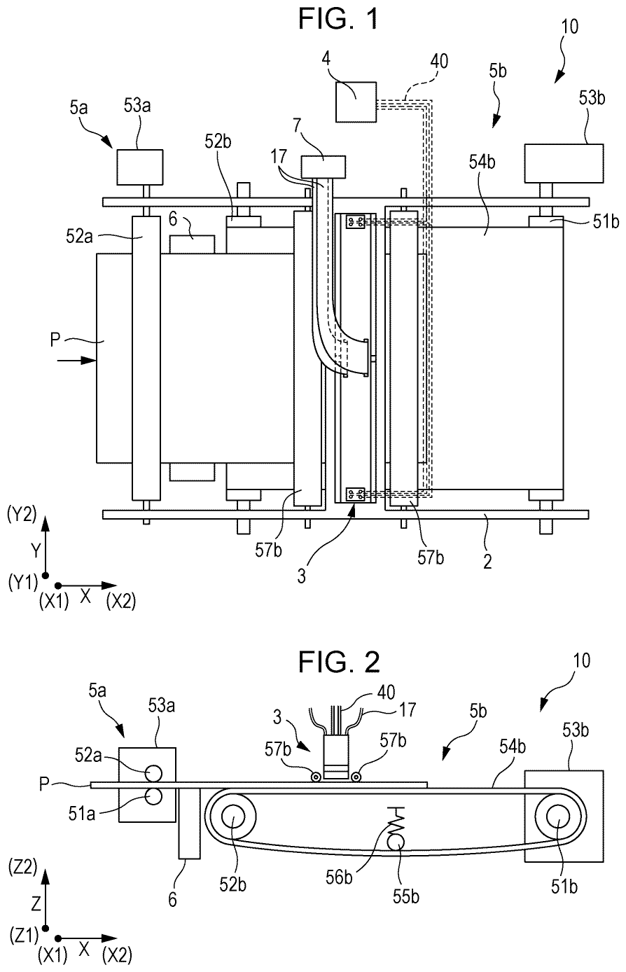

FIG. 1 is a top view illustrating a schematic configuration of a liquid ejection apparatus 10. FIG. 2 is a side view illustrating the schematic configuration of the liquid ejection apparatus 10. As illustrated in these drawings, the liquid ejection apparatus 10 to be described in the present embodiment will be described as an example of a so-called line type ink jet printer that performs printing only by transporting a medium P on which ink is ejected. The liquid ejection apparatus 10 is not limited to the line type ink jet printer, and may be a so-called serial type ink jet printer in which the head unit moves in synchronization with the transport of the medium P.

In the following description, a transport direction in which the medium P is transported will be referred to as a direction X, an upstream part the transport of the medium P will be described as an X1 side, and a downstream part of the transport of the medium P will be described as an X2 side. In addition, in an in-plane direction of a landing surface on which the ink lands on the medium P, a direction orthogonal to the direction X will be referred to as a direction Y, and one end of the liquid ejection apparatus 10 in the direction Y will be referred to as a Y1 side, and the other end will be referred to as a Y2 side. Further, a direction that is orthogonal to both the direction X and the direction Y and that is a direction in which ink ejected from a head unit 3 to the medium P is ejected, will be referred to as a direction Z, and the ink ejected from the head unit 3 is ejected from a Z2 side to a Z1 side in the direction Z. In the present embodiment, the direction X, the direction Y, and the direction Z are axes orthogonal to each other, but the configurations of the liquid ejection apparatus 10 are not limited to being disposed to be orthogonal to each other. These directions X, Y, and Z are also illustrated as appropriate in other drawings.

As illustrated in FIGS. 1 and 2, the liquid ejection apparatus 10 includes an apparatus body 2, the head unit 3, a storage section 4, a medium transport mechanism 5, and a maintenance mechanism 6. First, main components of the liquid ejection apparatus 10 will be described.

The storage section 4 stores the ink supplied to the head unit 3. The storage section 4 is fixed to the apparatus body 2. An ink cartridge, a bag-shaped ink pack formed of a flexible film, an ink tank that can be replenished with the ink, or the like is used as the storage section 4 in which such ink is stored. The ink stored in the storage section 4 is supplied to the head unit 3 via a supply pipe 40 such as a tube. Here, the storage section 4 may store the ink of a plurality of colors such as black, cyan, magenta, yellow, red, and gray. Accordingly, the storage section 4 may include a plurality of ink cartridges, a plurality of ink packs, and a plurality of ink tanks corresponding to the colors of the stored ink, and further, the supply pipe 40 may include a plurality of tubes corresponding to the colors of the ink stored in the storage section 4. In addition, the storage section 4 may be mounted on the head unit 3.

A signal for controlling the ejection of the ink is supplied from a drive circuit substrate 7 to the head unit 3 via a cable 17. The head unit 3 ejects the ink supplied from the storage section 4 in an amount corresponding to the signal supplied from the drive circuit substrate 7 and at a timing corresponding to the signal supplied from the drive circuit substrate 7. Details of the head unit 3 will be described below.

The medium transport mechanism 5 includes a first transport section 5a and a second transport section 5b. The first transport section 5a is located on the X1 side of the head unit 3. At least a part of the second transport section 5b is located on the X2 side of the head unit 3. The first transport section 5a and the second transport section 5b transport the medium P from the X1 side to the X2 side in a direction along the direction X.

The first transport section 5a includes a transport roller 51a, a driven roller 52a, and a drive motor 53a. A drive force is supplied from the drive motor 53a to the transport roller 51a. The transport roller 51a is rotationally driven in accordance with the drive force supplied from the drive motor 53a. The transport roller 51a nips the medium P together with the driven roller 52a and transports the medium P toward the X2 side. The driven roller 52a may include a spring (not illustrated) or the like that presses the medium P toward the transport roller 51a by stress generated by a biasing member.

The second transport section 5b includes a transport roller 51b, a driven roller 52b, a drive motor 53b, a transport belt 54b, a tension roller 55b, a biasing member 56b, and a pressing roller 57b.

The transport roller 51b is located on the X2 side of the head unit 3 in the direction X. A drive force is supplied from the drive motor 53b to the transport roller 51b. The transport roller 51b is rotationally driven in accordance with the drive force supplied from the drive motor 53b. The driven roller 52b is provided at a position separated by a predetermined distance from the transport roller 51b on the X1 side, and the transport belt 54b, which is an endless belt, is stretched between the driven roller 52b and the transport roller 51b. When the transport roller 51b is rotationally driven in accordance with the drive force supplied from the drive motor 53b, the transport belt 54b is driven thereby, and the medium P fed by the driven roller 52a and the transport roller 51a is transported downstream, that is, to the X2 side. The tension roller 55b is located between the transport roller 51b and the driven roller 52b, abuts on an inner peripheral surface of the transport belt 54b, and applies tension to the transport belt 54b by a biasing force generated by the biasing member 56b such as a spring.

The pressing roller 57b is provided on each of the X1 side and the X2 side of the head unit 3 on the Z2 side of the medium P. Further, a posture of the medium P is kept flat by the medium P being nipped between the pressing roller 57b and the transport belt 54b. In order to more precisely hold the position and the posture of the medium P, a flat platen may be provided on the Z1 side of the transport belt 54b directly below (on the Z1 side) of the head unit 3.

In the liquid ejection apparatus 10 configured as described above, the medium P is transported from the X1 side to the X2 side in a direction along the direction X by driving the first transport section 5a and the second transport section 5b. The ink is ejected from the head unit 3 to the medium P to be transported, at a predetermined timing. As a result, the ink ejected from the head unit 3 lands at a desired position on the medium P, and a desired image is formed on the medium P.

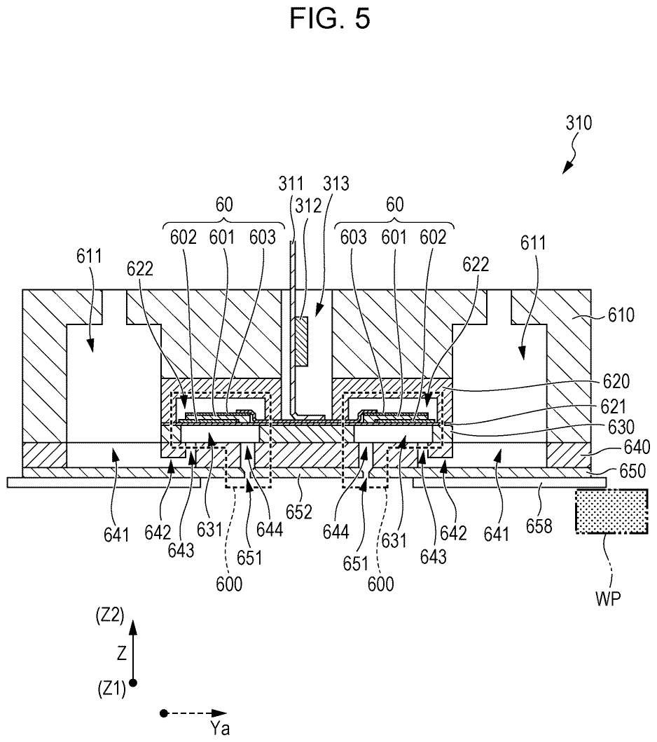

The maintenance mechanism 6 implements a maintenance function such that the head unit 3 can normally eject the ink. The maintenance mechanism 6 is used, for example, for wiping, flushing, cleaning, and further capping. The wiping is a process of, in order to remove ink, paper pieces, or the like adhering to a surface (hereinafter, referred to as a nozzle surface) on which the ink is ejected from the head unit 3 by a wiping member WP (see FIG. 5) included in the maintenance mechanism 6, wiping a nozzle surface. The flushing is a process of ejecting the ink from the nozzle by driving a piezoelectric element 60 described below in a state in which a container (not illustrated) having a recessed shape included in the maintenance mechanism 6 faces the nozzle surface in order to maintain the viscosity of the ink stored inside the head unit 3 in an appropriate range, or to recover the viscosity of the ink to an appropriate state when the viscosity of the ink stored inside the head unit 3 is abnormal.

### A2. Structure of Head Unit

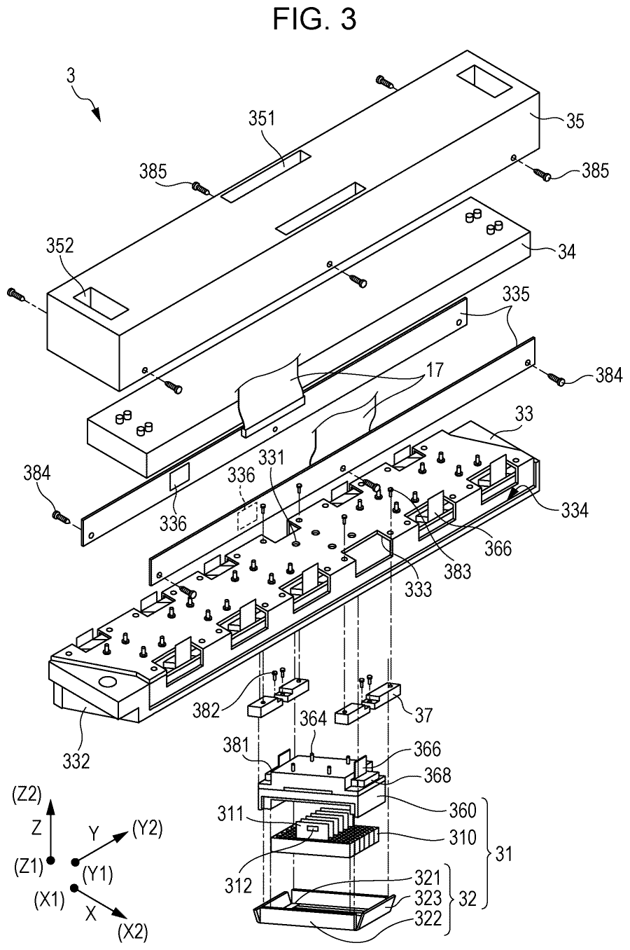

Next, a structure of the head unit 3 will be described. FIG. 3 is a partial exploded perspective view illustrating the structure of the head unit 3. As illustrated in the drawing, the head unit 3 includes a plurality of liquid ejection heads 31, a base member 33, a flow channel member 34, and a cover member 35. FIG. 3 illustrates a case in which the head unit 3 includes six liquid ejection heads 31, but the number of liquid ejection heads 31 included in the head unit 3 is not limited thereto.

The liquid ejection head 31 includes a plurality of head chips 310 and a holding member 360 that holds the head chips 310. In the present embodiment, the liquid ejection head 31 includes six head chips 310, but the number of head chips 310 included in one liquid ejection head 31 may be more than or less than six.

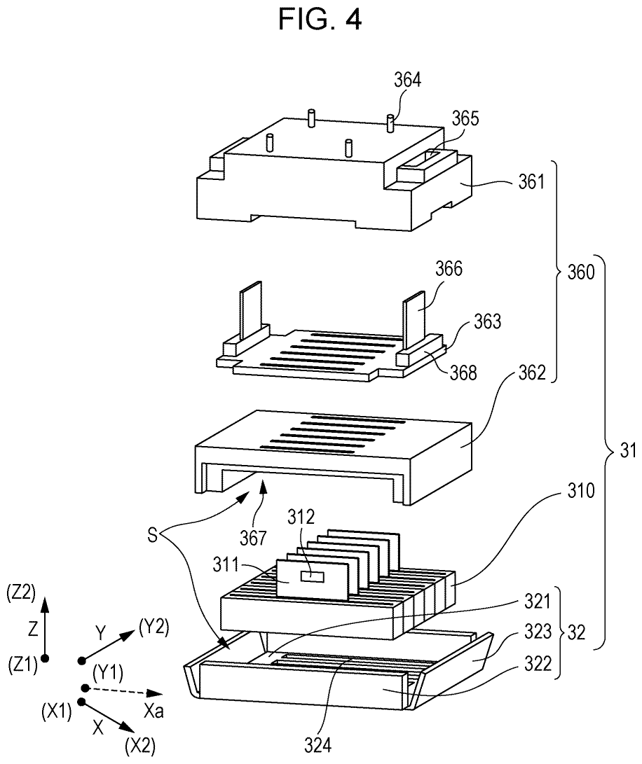

A detailed structure of the liquid ejection head 31 including the six head chips 310 is illustrated in FIG. 4 that is an exploded perspective view. The plurality of head chips 310 included in the liquid ejection head 31 have the same structure within a range of manufacturing errors. An internal structure of the head chip 310 is illustrated in FIG. 5. FIG. 5 is a cross-sectional view of the head chip 310 illustrated in FIG. 4 cut in a Y-Z plane at the center in a longitudinal direction. As illustrated in FIG. 5, each head chip 310 includes a case 610, a protection substrate 620, a pressure chamber substrate 630, a flow channel substrate 640, and a nozzle plate 650. In the head chip 310, the case 610, the protection substrate 620, the pressure chamber substrate 630, the flow channel substrate 640, and the nozzle plate 650 are bonded to each other by an adhesive or the like. At least one of a plurality of types of adhesives that bond these members is in contact with the ink flowing through the flow channel in the head chip 310.

The structure of the head chip 310 will be described with reference to FIG. 5. The nozzle plate 650 includes a plurality of nozzles 651 that eject the ink. Specifically, on the nozzle plate 650, a plurality of (two) nozzle rows including the plurality of nozzles 651 arranged along a direction Xa that is the longitudinal direction of the head chip 310 are arranged in a direction along a direction Ya. Here, the direction Xa is a direction inclined with respect to the direction X that is the transport direction of the medium P, and the direction Ya is a direction intersecting with the direction Xa on an X-Y plane defined by the direction X and the direction Y. That is, the liquid ejection head 31 is mounted on the head unit 3 such that an arrangement direction of the nozzles 651 included in the head chip 310 is an inclined direction with respect to the direction X that is the transport direction of the medium P. The nozzle rows formed by the nozzles 651 are not limited to two rows, and may be one row or three or more rows. Here, a surface of the nozzle plate 650 on the Z1 side on which the nozzle 651 is open will be referred to as a nozzle surface 652. The head chip 310 includes one nozzle plate 650.

The pressure chamber substrate 630 is located on the Z2 side of the nozzle plate 650. The pressure chamber substrate 630 includes a plurality of pressure generation chambers 631 partitioned by a partition wall and the like. Each pressure generation chamber 631 is located corresponding to the nozzle 651 included in the nozzle plate 650. In other words, the pressure chamber substrate 630 includes the pressure generation chambers 631 in the same number as the nozzles 651 included in the nozzle plate 650. Further, the plurality of pressure generation chambers 631 included in the pressure chamber substrate 630 are arranged in parallel in a direction along the direction Xa. Two rows of the pressure generation chambers 631 arranged in parallel are located in a direction along the direction Ya.

The flow channel substrate 640 is located on the Z2 side of the nozzle plate 650 and the Z1 side of the pressure chamber substrate 630. In other words, the flow channel substrate 640 is located between the nozzle plate 650 and the pressure chamber substrate 630 in a direction along the direction Z. The flow channel substrate 640 includes a common flow channel 641, a branch flow channel 642, a communication flow channel 643, an individual flow channel 644 for supplying the ink supplied from the storage section 4 to each of the plurality of nozzles 651.

The individual flow channel 644 communicates with the corresponding nozzle 651 and the pressure generation chamber 631. The common flow channel 641 is provided in common to the plurality of pressure generation chambers 631 included in the pressure chamber substrate 630 and the plurality of nozzles 651 included in the nozzle plate 650. The ink is supplied from the storage section 4 to the common flow channel 641. The ink supplied to the common flow channel 641 is supplied to the pressure generation chamber 631 via the branch flow channel 642 and the communication flow channel 643 provided corresponding to the pressure generation chamber 631. In other words, the branch flow channel 642 and the communication flow channel 643 allow the common flow channel 641 and the corresponding pressure generation chamber 631 to communicate with each other. The flow channel substrate 640 configured as described above supplies the ink supplied to the common flow channel 641 to the pressure generation chamber 631 via the communication flow channel 643 after branching the ink so as to correspond to each of the plurality of pressure generation chambers 631 in the branch flow channel 642.

A diaphragm 621 is bonded to a surface of the pressure chamber substrate 630 on the Z2 side. In addition, a plurality of piezoelectric elements 60 corresponding to the plurality of pressure generation chambers 631 are provided on a surface of the diaphragm 621 on the Z2 side. The piezoelectric element 60 functions as an actuator that is driven to eject liquid such as ink from the nozzle 651. Although, in the present example, the piezoelectric actuator such as the piezoelectric element 60 is used as the actuator, a heating element or the like may be used as the actuator. The piezoelectric element 60 used in the present embodiment includes electrodes 602 and 603 and a piezoelectric layer 601, and the electrodes 602, the piezoelectric layer 601, and the electrodes 603 are laminated in this order from the Z1 side to the Z2 side in a direction along the direction Z on the surface of the diaphragm 621 on the Z2 side. Further, one of the electrode 602 or the electrode 603 of each piezoelectric element 60 is configured as a common electrode that supplies a signal of a common voltage value to the piezoelectric element 60 and the other of the electrode 602 or the electrode 603 is configured as an individual electrode that supplies a signal of an individual voltage value to each piezoelectric element 60. The electrode 602 will be described as an individual electrode, and the electrode 603 will be described as a common electrode in the present embodiment, but the present disclosure is not limited thereto. A drive signal COM is supplied to the electrode 602 that is the individual electrode, and a reference voltage signal indicating a reference potential Vbs of the drive signal COM is supplied to the electrode 603 that is the common electrode.

In the piezoelectric element 60 configured as described above, the piezoelectric layer 601 is deformed in accordance with a potential difference generated between the electrode 602 and the electrode 603. In other words, the piezoelectric element 60 is driven in accordance with a potential difference between the voltage value of the signal supplied to the electrode 602 and the voltage value of the signal supplied to the electrode 603. Then, the diaphragm 621 is displaced by driving of the piezoelectric element 60. An internal pressure of the pressure generation chamber 631 decreases when the diaphragm 621 is displaced to the Z2 side. As a result, the ink is supplied from the common flow channel 641 to the pressure generation chamber 631 via the branch flow channel 642 and the communication flow channel 643. On the other hand, the internal pressure of the pressure generation chamber 631 rises when the diaphragm 621 is displaced to the Z1 side. As a result, the ink stored in the pressure generation chamber 631 is ejected from the nozzle 651 via the individual flow channel 644. Here, the configuration including the piezoelectric element 60, the pressure generation chamber 631, the individual flow channel 644, and the nozzle 651 will be referred to as an ejection section 600 that ejects the ink from the head chip 310.

The protection substrate 620 is located on the Z2 side of the diaphragm 621. The protection substrate 620 includes a holding section 622 that forms a space for protecting the piezoelectric element 60. The space formed by the holding section 622 has a sufficient size with respect to the displacement caused by the driving of the piezoelectric element 60.

The case 610 is located on the Z2 side of the flow channel substrate 640 and the protection substrate 620. The case 610 includes a manifold 611 communicating with the common flow channel 641 of the flow channel substrate 640. The manifold 611 is a space for storing the ink supplied to the plurality of nozzles 651, and is continuously provided over the plurality of nozzles 651 and the plurality of pressure generation chambers 631. The ink supplied to the manifold 611 is supplied to the common flow channel 641. That is, the common flow channel 641 and the manifold 611 are common liquid chambers communicating with the plurality of nozzles 651. The common liquid chamber extends in the direction Xa in which the plurality of nozzles 651 are arranged, as the longitudinal direction.

In addition, in the liquid ejection head 31, the protection substrate 620 and the case 610 are provided with a through-hole 313 penetrating in a direction along the direction Z. A flexible wiring substrate 311 is inserted through the through-hole 313. One end of the flexible wiring substrate 311 is electrically coupled to a lead electrode pulled out from the electrodes 602 and 603 of the piezoelectric element 60. That is, a signal for driving the piezoelectric element 60 propagates to the flexible wiring substrate 311. Further, an integrated circuit 312 is mounted on the flexible wiring substrate 311. The signal for driving the piezoelectric element 60 propagating on the flexible wiring substrate 311 is input to the integrated circuit 312. The integrated circuit 312 controls a timing at which the signal for driving the piezoelectric element 60 is supplied to the electrode 602 based on the input signal. As a result, a timing at which the piezoelectric element 60 is driven and an amount of driving of the piezoelectric element 60 are controlled. Accordingly, a predetermined amount of ink is ejected at a predetermined timing from the ejection section 600 including the piezoelectric element 60. A water-repellent film 658 is formed on the outside of the nozzle plate 650, and, when the surface of the head chip 310 is dirty, the nozzle plate 650 is wiped by the wiping member WP included in the maintenance mechanism 6.

The pressure fluctuation for ejecting the ink from the nozzle 651 is generated by the piezoelectric element 60 including the electrode 603, the piezoelectric layer 601, and the electrode 602, one pressure generation chamber 631, and the diaphragm 621 in the head chip 310. The piezoelectric element 60, the pressure generation chamber 631, and the diaphragm 621 will also be referred to as a segment. The head chip 310 includes such segments in the same number as the nozzles 651. The segments have various features related to the ejection of the liquid. Examples of the various features include a natural frequency of the segment, the weight of the ink droplet ejected from the nozzle 651, the speed of the ink droplet ejected from the nozzle 651, the displacement amount of the diaphragm 621 of the segment, and the like.

The natural frequency of the segment can be measured by a known device or method. For example, a known impedance analyzer is used as a measurement device, a specific Sin wave is input to the segment to measure the impedance. The impedance of the segment changes by changing the frequency of the input Sin wave. The frequency of the input Sin wave having an impedance peak can be measured as the natural frequency of the segment. The natural frequency is a value correlated with a natural vibration cycle Tc of the liquid in the pressure generation chamber 631.

The weight of the ink droplet ejected from the nozzle 651 can be measured by a known device or method. For example, the drive signal COM including a specific drive waveform (reference drive waveform) in which the liquid droplet can be ejected to the piezoelectric element 60 is applied, and a constant number of liquid droplets are ejected to a receiving container. The weight of the ink droplet ejected from the nozzle 651 can be measured by measuring the weight change of the receiving container or the weight change of the storage section 4 that is an ink supply source. For this measurement, a high-precision weight meter such as an electronic balance can be used.

The displacement amount of the diaphragm 621 of the segment is a difference between a maximum value and a minimum value of the displacement of a vibration section caused by piezoelectric strain of the piezoelectric element 60. The displacement amount of the diaphragm 621 of the segment will also be simply referred to as the displacement amount of the segment. The displacement amount of the segment can be measured by a known device or method. For example, since the speed at which the diaphragm 621 moves due to the vibration can be measured by using a Doppler vibrometer that utilizes the difference in wavelength in the round trip of the laser that is irradiated by being reflected by the diaphragm 621, the displacement amount of the diaphragm 621 can be measured by integrating the speed.

The natural frequency of the segment, the weight of the ink droplet ejected from the nozzle 651, the speed of the ink droplet ejected from the nozzle 651, the displacement amount of the diaphragm 621, and the like can be used for ranking of the head chips described below. In a plurality of segments included in one head chip 310, the above-described measurement values such as the natural frequency may be different from each other. In this case, the ranking need only be performed by an average value or a mode of the measurement values of the plurality of segments included in one head chip.

The head chip 310 configured as described above is held by the holding member 360 in the liquid ejection head 31. As illustrated in FIG. 4, the holding member 360 includes a flow channel member 361 common to the plurality of head chips 310, a holder 362 that holds the plurality of head chips 310, and a first relay substrate 363 electrically coupled to at least two or more head chips 310. The first relay substrate 363 according to the present embodiment is electrically coupled to all the head chips 310 included in the liquid ejection head 31.

Inside the flow channel member 361, a flow channel for supplying the ink supplied from the storage section 4 via the flow channel member 34 to each head chip 310 is provided. The flow channel communicates with an ink supply section 364 provided on a surface of the flow channel member 361 on the Z2 side. In other words, the ink supplied from the storage section 4 is supplied to the flow channel member 361 via the ink supply section 364. The flow channel provided in the flow channel member 361 is provided corresponding to each ink supply section 364. Here, the flow channel member 361 that includes the four ink supply sections 364 is illustrated in FIG. 4, but the present disclosure is not limited thereto. In addition, a filter for removing foreign matters such as dust and air bubbles contained in the supplied ink may be provided in the flow channel member 361.

A cable insertion hole 365 penetrating the flow channel member 361 in the direction Z is provided at both end portions of the flow channel member 361 along the direction X. A cable 366 electrically coupled to the first relay substrate 363 described below via a connector 368 is inserted into the cable insertion hole 365. Here, the connector 368 is detachably coupled to the cable 366 and is electrically coupled to a plurality of terminals corresponding to each of a plurality of wirings included in the cable 366.

The holder 362 is located on the Z1 side of the flow channel member 361, and is fixed to the flow channel member 361 by a screw 381 illustrated in FIG. 3. In addition, the holder 362 includes a holding section 367. The holding section 367 is a groove-shaped space that is continuous over the direction Y and is open to both side surfaces in the direction Y, on the surface of the holder 362 on the Z1 side. Further, the plurality of head chips 310 are bonded to the holding section 367 by an adhesive (not illustrated) or the like. As a result, the plurality of head chips 310 are held by the holding member 360.

Further, a flow channel (not illustrated) communicating with a flow channel provided inside the flow channel member 361 is provided inside the holder 362. The ink supplied from the ink supply section 364 is supplied to each head chip 310 via the flow channel provided inside the flow channel member 361 and the flow channel provided inside the holder 362. That is, the holder 362 is a flow channel member common to the plurality of head chips 310.

The first relay substrate 363 is located between the flow channel member 361 and the holder 362. The flexible wiring substrate 311 included in each head chip 310 is electrically coupled to the first relay substrate 363. In addition, the first relay substrate 363 is provided with the connector 368. The first relay substrate 363 configured as described above propagates the signal input via the cable 366 electrically coupled to the connector 368 to the corresponding head chip 310, and outputs the signal output from each head chip 310 via the flexible wiring substrate 311 to the outside of the liquid ejection head 31 via the connector 368 and the cable 366. In addition, the first relay substrate 363 includes a memory 201.

The liquid ejection head 31 described above includes a cover 32 that covers the plurality of head chips 310 with the holder 362. In other words, the plurality of head chips 310 are disposed inside an accommodation space S that is a space defined by the holding section 367 of the holder 362 and the cover 32. As a result, the risk of the ink droplet that floats in the liquid ejection apparatus 10 adhering to each head chip 310 is reduced. In other words, the cover 32 protects the head chip 310 included in the liquid ejection head 31 from the ink droplet.

The cover 32 is provided on the Z1 side that is the nozzle surface 652 side of the plurality of head chips 310 provided in the liquid ejection head 31. As illustrated in FIG. 4, the cover 32 includes a base section 321 and extension sections 322 and 323. The base section 321 is a plate-shaped member provided on the nozzle surface 652 side of the head chip 310 covered with the cover 32. The cover 32 forms a space with the base section 321 and the extension sections 322 and 323, and the holder 362 is inserted into the formed space. The base section 321 is bonded to a surface of the holder 362 on the Z1 side by an adhesive (not illustrated) or the like.

The base section 321 has a plurality of opening portions 324. Each of the opening portions 324 corresponds to each head chip 310, and exposes the plurality of nozzles 651 of the corresponding head chip 310 to the outside. As a result, the ink ejected from each head chip 310 lands on the medium P without being hindered by the cover 32.

Returning to FIG. 3, the plurality of liquid ejection heads 31 are fixed to the base member 33. The base member 33 includes an accommodation section 332 having a space open to the Z1 side. The plurality of liquid ejection heads 31 are accommodated and held in the space. Specifically, the liquid ejection head 31 is accommodated in the accommodation section 332 of the base member 33 such that the nozzle surface 652 side of the liquid ejection head 31 protrudes from the accommodation section 332 to the Z1 side. In this case, each of the plurality of liquid ejection heads 31 is accommodated in the accommodation section 332 such that the nozzle row located on the nozzle surface 652 is in a direction along the direction Xa inclined with respect to the direction X.

When the liquid ejection head 31 is accommodated in the base member 33, the liquid ejection head 31 is fixed to the base member 33 via a spacer 37. The spacer 37 is fixed to the surface of the liquid ejection head 31 on the Z2 side by a screw 382 and is fixed to the surface of the base member 33 on the Z1 side by a screw 383. That is, the liquid ejection head 31 is fixed to the base member 33 via the spacer 37. As described above, by fixing the spacer 37, which is fixed to the liquid ejection head 31 by the screw 382, to the base member 33 by the screw 383, it is possible to easily attach and detach the liquid ejection head 31 to and from the base member 33. The spacer 37 and the liquid ejection head 31 are not limited to being fixed by using the screw 382.

The base member 33 has a supply hole 331 penetrating the base member 33 in the direction Z. The ink supply section 364 of the liquid ejection head 31 fixed to the base member 33 is inserted into the supply hole 331. Further, the base member 33 has an opening portion 333 penetrating the base member 33 in the direction Z. The cable 366 included in the head unit 3 fixed to the base member 33 is inserted into the opening portion 333.

Steps 334 opening to the Z2 side are provided on the outer peripheries of both sides of the accommodation section 332 that face each other in a direction along the direction X. A second relay substrate 335 is accommodated in each of steps 334. The cable 366 corresponding to each of the plurality of liquid ejection heads 31 led out from the plurality of opening portions 333 is electrically coupled to the second relay substrate 335. As a result, the signal input to each of the plurality of liquid ejection heads 31 and the signals output from the plurality of liquid ejection heads 31 propagate through the second relay substrate 335.

Further, an integrated circuit 336 is mounted on the second relay substrate 335. In the head unit 3 illustrated in FIG. 3, two second relay substrates 335 are illustrated, and a case is illustrated in which each of the two second relay substrates 335 includes the integrated circuit 336. However, a configuration may be adopted in which the integrated circuit 336 is included in only one of the two second relay substrates 335, and a configuration may be adopted in which the head unit 3 includes only one second relay substrate 335. The two second relay substrates 335 are each fixed to the accommodation section 332 by screws 384.

A cable 17, which is electrically coupled to the drive circuit substrate 7 fixed to the apparatus body 2, is coupled to the second relay substrate 335. As a result, various signals generated by the drive circuit substrate 7 are input to the head unit 3. The electrical wirings of the head chip 310, the integrated circuit 312, the first relay substrate 363, the second relay substrate 335, and the like will be described below.

The flow channel member 34 is provided on the Z2 side of the base member 33. The flow channel member 34 is a flow channel member common to the plurality of liquid ejection heads 31, and distributes and supplies the ink supplied from the storage section 4 to each of the plurality of liquid ejection heads 31. A flow channel (not illustrated) for supplying the ink supplied from the storage section 4 to the plurality of liquid ejection heads 31 is provided inside the flow channel member 34. The flow channel provided inside the flow channel member 34 communicates with the supply pipe 40 coupled to the storage section 4 and communicates with the ink supply section 364 of the liquid ejection head 31. As a result, the ink supplied from the storage section 4 is supplied to the corresponding liquid ejection head 31.

The cover member 35 is provided on the Z2 side of the flow channel member 34. The cover member 35 is a box-shaped member that covers the flow channel member 34 and the second relay substrate 335. The cover member 35 is provided with an opening portion 351 for inserting the cable 17 and an opening portion 352 for inserting the supply pipe 40. The cover member 35 is fixed to the accommodation section 332 of the base member 33 by a screw 385.

As described above, the head unit 3 is the head unit 3 installed in the liquid ejection apparatus 10 that ejects the ink to the medium P, the head unit 3 includes the plurality of liquid ejection heads 31, and each liquid ejection head 31 includes the plurality of head chips 310.

### A3. Functional Configuration of Liquid Ejection Apparatus

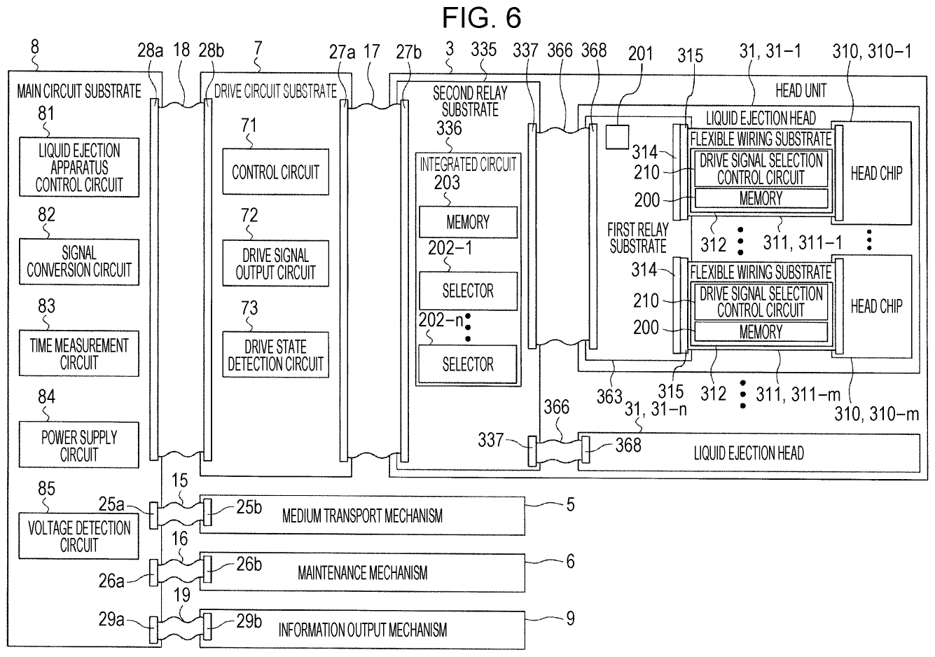

Next, a functional configuration of the liquid ejection apparatus 10 will be described. FIG. 6 is a view illustrating the functional configuration of the liquid ejection apparatus 10. As illustrated in the drawing, the liquid ejection apparatus 10 includes the head unit 3, the medium transport mechanism 5, the maintenance mechanism 6, the drive circuit substrate 7, a main circuit substrate 8, and an information output mechanism 9. Since the configuration of the medium transport mechanism 5 has already been described, the head unit 3, the maintenance mechanism 6, the drive circuit substrate 7, the main circuit substrate 8, and the information output mechanism 9 will be described below in sequence.

A hardware configuration of the head unit 3 has already been described in detail. An electrical configuration inside the head unit 3 will be described with reference to FIG. 6. As illustrated in the drawing, the head unit 3 includes n liquid ejection heads 31, and each of the liquid ejection heads 31 includes m head chips 310. That is, the head unit 3 will be described as having a total of n×m head chips 310. Here, n and m are both integers of 2 or more. In the liquid ejection head 31, each head chip 310 is coupled to the first relay substrate 363 via m flexible wiring substrates 311. The coupling between the first relay substrate 363 and each head chip 310 is implemented by coupling a connector 315 provided at the other end of the flexible wiring substrate 311 to the connector 314 of the first relay substrate 363. The connector 315 and the connector 314 are detachably coupled to each other. The first relay substrate 363 integrates drive signal wirings for supplying the common drive signal COM to the m head chips 310.

In the following description, when the n liquid ejection heads 31 are distinguished, the liquid ejection heads 31 may be referred to as liquid ejection heads 31-1 to 31-n, and similarly, when the m head chips 310 or the flexible wiring substrates 311 are distinguished, the head chips 310 may be referred to as head chips 310-1 to 310-m or the flexible wiring substrates 311 may be referred to as flexible wiring substrates 311-1 to 311-m. When it is not necessary to distinguish the liquid ejection heads 31-1 to 31-n, the flexible wiring substrates 311-1 to 311-m, or the head chips 310-1 to 310-m, the liquid ejection heads 31-1 to 31-n, the flexible wiring substrates 311-1 to 311-m, or the head chips 310-1 to 310-m will be simply referred to as the liquid ejection head 31, the flexible wiring substrate 311, and the head chip 310.

Each flexible wiring substrate 311 is provided with the integrated circuit 312. The integrated circuit 312 includes a memory 200 and a drive signal selection control circuit 210. The memory 200 stores data such as the use history of the head chip 310 including the memory 200. The drive signal selection control circuit 210 selects a signal to be provided to the plurality of piezoelectric elements 60 included in the head chip 310, and ejects the liquid, here, the ink, from a desired nozzle 651 among the plurality of nozzles 651 included in the head chip 310.

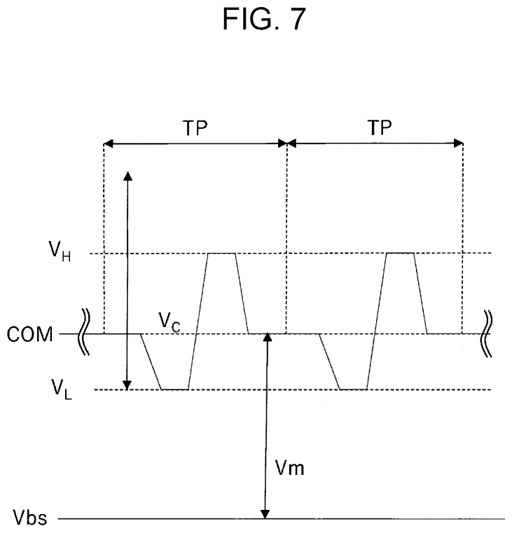

The head chip 310 is provided with the piezoelectric element 60 that generates a pressure change for ejection, corresponding to each of the plurality of nozzles 651. When the piezoelectric element 60 receives the drive signal COM having a predetermined drive waveform via the drive signal selection control circuit 210, the piezoelectric element 60 expands and contracts along the direction Z in accordance with an applied voltage waveform. The drive signal COM and the reference voltage signal are illustrated in FIG. 7.

The drive signal selection control circuit 210 includes a plurality of switching elements provided corresponding to each of the plurality of piezoelectric elements 60. The switching element selects whether or not to supply the drive signal COM to the individual electrode of the corresponding piezoelectric element 60 for each printing cycle TP based on a clock signal (not illustrated), a latch signal (not illustrated), a change signal (not illustrated), a printing data signal (not illustrated), and the like.

As illustrated in FIG. 7, the drive signal COM is, for example, a trapezoidal wave, and includes a period for maintaining a minimum potential V_{L}, a period for maintaining a maximum potential V_{H}, a period for maintaining an intermediate potential V_{C} between the minimum potential V_{L} and the maximum potential V_{H}, and a plurality of periods having an inclination that couples these periods for maintaining the potentials. The reference voltage signal is a signal in which the constant reference potential Vbs smaller than the minimum potential V_{L} is continuous. During a period in which the power is supplied to the liquid ejection head 31, normally, the intermediate potential V_{C} of the drive signal COM is applied to the individual electrode of the piezoelectric element 60 during a period in which the liquid is not ejected from the nozzle 651, and the reference potential Vbs of the reference voltage signal is applied to the common electrode. Therefore, the reference voltage Vm of the drive signal COM, which is the potential difference between the intermediate potential V_{C} of the drive signal COM and the reference voltage signal Vbs, affects the amount of deformation and the temporal change of the deformation characteristics of the piezoelectric element 60. Therefore, the magnitude of the reference voltage Vm may be treated as one of the use histories of the head chip 310. In addition, an environmental temperature of the head chip 310 may also be treated as the use history. The environmental temperature of the head chip 310 need only be detected by providing a temperature sensor in the integrated circuit 312 or the like, but a temperature in a housing of the liquid ejection apparatus 10, a temperature around the head chip 310, or the like may be treated as the environmental temperature. The environmental temperature of the head chip 310 may be regarded as an environmental temperature of the liquid ejection head 31. A method of storing the reference voltage Vm and the environmental temperature in the memory 200 of the head chip 310 and treating the reference voltage Vm and the environmental temperature as the use history will be described below.

The signal from the head chip 310, the drive signal COM to the head chip 310, and the like are integrated on the first relay substrate 363. The n first relay substrates 363 are coupled to the second relay substrate 335 by the cable 366. The cable 366 is coupled to the connector 368 provided on the first relay substrate 363 and the connector 337 provided on the second relay substrate 335, to electrically couple the two substrates. The integrated circuit 336 is provided on the second relay substrate 335. The integrated circuit 336 includes a memory 203 and n selectors 202. Each of the n selectors 202 is provided corresponding to the liquid ejection heads 31-1 to 31-n. The printing data signal, a memory control signal, the latch signal, and a change signal input from the drive circuit substrate 7 are input to the selector 202. Then, the selector 202 selects whether to output the printing data signal, the latch signal, and the change signal to the liquid ejection head 31 or to output the memory control signal, the latch signal, and the change signal to the memory 200 of the flexible wiring substrate 311, in accordance with the logic levels of the input latch signal and the input change signal.

The head unit 3 described above is electrically coupled to the drive circuit substrate 7 via the second relay substrate 335. The second relay substrate 335 and the drive circuit substrate 7 are coupled to each other via the cable 17. The cable 17 has one end coupled to the connector 27b provided on the second relay substrate 335 and has the other end coupled to the connector 27a provided on the drive circuit substrate 7, so that the cable 17 mediates the exchange of signals between the connectors 27a and 27b.

The drive circuit substrate 7 includes a control circuit 71, a drive signal output circuit 72, and a drive state detection circuit 73. The control circuit 71 outputs a memory control signal for controlling the memory 203 of the second relay substrate 335. Here, the control of the memory 203 includes a read process of reading information stored in the memory 203, a write process of writing information in the memory 203, and the like. The control circuit 71 generates a drive data signal that defines the voltage waveform of the drive signal COM for driving the piezoelectric element 60 and outputs the generated drive data signal to the drive signal output circuit 72. The drive signal output circuit 72 amplifies the voltage waveform defined by each of the drive data signals.

The drive state detection circuit 73 generates an ejection section state signal indicating a state of the corresponding ejection section 600 based on a residual vibration signal input from the head chip 310 via the first relay substrate 363 and the second relay substrate 335. The drive state detection circuit 73 outputs the ejection section state signal to the control circuit 71. The control circuit 71 determines whether or not to cause the maintenance mechanism 6 to perform the wiping process, the flushing process, the cleaning process, or the like based on the input ejection section state signal, generates an operation information signal indicating the determination result, and outputs the operation information signal to the liquid ejection apparatus control circuit 81 via a cable 18 or the like.

The main circuit substrate 8 includes a liquid ejection apparatus control circuit 81, a signal conversion circuit 82, a time measurement circuit 83, a power supply circuit 84, and a voltage detection circuit 85. A connector 25a, a connector 26a, a connector 28a, and a connector 29a are provided on the main circuit substrate 8. The main circuit substrate 8 is coupled to the drive circuit substrate 7 via the cable 18 coupled to the connector 28a, is coupled to the medium transport mechanism 5 via the cable 15 coupled to the connector 25a, is coupled to the maintenance mechanism 6 via the cable 16 coupled to the connector 26a, and is coupled to the information output mechanism 9 via a cable 19 coupled to the connector 29a. Each of the substrates and the mechanisms to be coupled are provided with connectors 28b, 25b, 26b, and 29b to which the other ends of the cables 18, 15, 16, and 19 are coupled. The type of each connector that appears in the present specification is not limited as long as the connector has a structure in which the wiring members are detachably electrically coupled to each other without using bonding such as conductive bonding or soldering. Here, the connector 314 and the connector 315 described above are a connector having a protruding shape and a connector having a recessed shape, and are detachably electrically coupled to each other by inserting and pulling out the connector having a protruding shape into and from the connector having a recessed shape. As described above, a configuration may be used in which a connector other than the connectors 314 and 315 is coupled to a connector different from the connector.

The liquid ejection apparatus control circuit 81 exchanges signals with each section provided in the liquid ejection apparatus 10, and controls the operation of each section. For example, the liquid ejection apparatus control circuit 81 exchanges an instruction signal for transporting the medium P, transport information on the transported medium P, and the like with the medium transport mechanism 5. Further, the liquid ejection apparatus control circuit 81 exchanges a control signal for controlling the operation of the maintenance mechanism 6 with the maintenance mechanism 6. Similarly, the liquid ejection apparatus control circuit 81 exchanges a control signal for controlling the operation of the information output mechanism 9 with the information output mechanism 9. Further, the liquid ejection apparatus control circuit 81 inputs an image data signal from an external device such as a host computer provided outside the liquid ejection apparatus 10, performs a necessary process on the image data signal, and then outputs the processed image data signal to the signal conversion circuit 82. The signal conversion circuit 82 converts the input image data signal into an image signal corresponding to the ink color used in the liquid ejection apparatus 10, and outputs the converted image signal to the drive circuit substrate 7.

An external commercial power supply is input to the power supply circuit 84. The power supply circuit 84 converts the input commercial power supply into a DC voltage of, for example, 42 V and outputs the converted DC voltage. The DC voltage output from the power supply circuit 84 is input to the voltage detection circuit 85 and is also used as a power supply voltage of each configuration of the liquid ejection apparatus 10. The voltage detection circuit 85 detects whether or not the power is normally supplied to the liquid ejection apparatus 10 based on a voltage value of the DC voltage. The voltage detection circuit 85 generates a voltage detection signal of a logic level according to a detection result and outputs the generated voltage detection signal to the time measurement circuit 83. For example, the voltage detection circuit 85 outputs a voltage detection signal VDET of an L level to the time measurement circuit 83 when the voltage value of the DC voltage deviates from a predetermined range, and outputs a voltage detection signal VDET of an H level to the time measurement circuit 83 when the voltage value of the voltage enters the predetermined range. The time measurement circuit 83 determines whether or not the power supply voltage is supplied to the liquid ejection apparatus 10 based on the voltage detection signal. Then, when the time measurement circuit 83 determines that the power supply voltage is supplied to the liquid ejection apparatus 10 based on the voltage detection signal, the time measurement circuit 83 generates elapsed time information and outputs the generated elapsed time information to the liquid ejection apparatus control circuit 81. The elapsed time information is used to count a use time of the liquid ejection apparatus 10 and ultimately the head chip 310.

The information output mechanism 9 outputs various types of information to a user of the liquid ejection apparatus 10. The liquid ejection apparatus control circuit 81 generates a control signal for controlling the operation of the information output mechanism 9, and outputs the control signal to the information output mechanism 9 via the cable 19 coupled to the connector 29a. The information output mechanism 9 includes, for example, a display for display. The display for display displays various types of information such as information indicating an operation state of the liquid ejection apparatus 10, information indicating an operation state of the maintenance mechanism 6, information related to a use history of the head unit 3, and warning information. The information output mechanism 9 need only be configured to notify the user of various types of information, and may have a configuration for notifying the user of information by voice, light, or the like.

### A4. Cycle of Reusing Head Chip

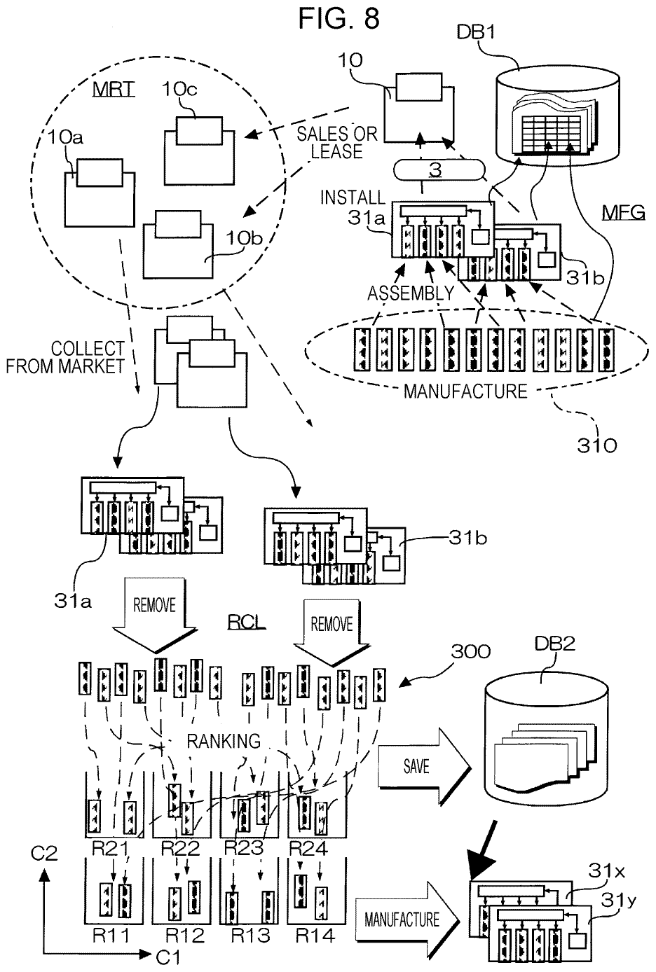

As described above, the head unit 3 incorporated in the liquid ejection apparatus 10 is provided with the plurality of liquid ejection heads 31, and the plurality of head chips 310 are further incorporated in the liquid ejection head 31. In order to describe the manufacturing method of the liquid ejection head according to the present embodiment, a process of manufacturing a new head chip 310, releasing the head chip 310 to the market, collecting the head chip 310, and reusing the head chip 310 will be briefly described with reference to FIG. 8. The terms used in the description are defined as follows.
Head chip 310: A head chip having no use history and a head chip having a use history but being used in a product until being collected.
Used head chip 300: A head chip that has a use history and that is collected, in which, even in a state of being attached to the head unit 3 or the liquid ejection head 31, the head chip 300 provided in the collected product will be referred to as the used head chip 300.
First liquid ejection head 31: A liquid ejection head from which the used head chip 300 to be reused is extracted, in which, in the description of the hardware configuration, the liquid ejection head 31 is consistently referred to as the liquid ejection head 31, but the liquid ejection head from which the used head chip 300 is removed for reuse will be referred to as the first liquid ejection head in order to distinguish from the liquid ejection head to be manufactured.
Second liquid ejection head 31: A liquid ejection head manufactured by using at least a part of the used head chip 300 removed from the first liquid ejection head 31.
Third liquid ejection head: A liquid ejection head from which the used head chip 300 to be reused is extracted, similarly to the first liquid ejection head, and a liquid ejection head different from the first liquid ejection head and the second liquid ejection head.
Ejection performance of the used head chip: Information related to the ability of the used head chip 300 to eject the liquid at the point in time of collection of the used head chip 300, in other words, the degree of deterioration of the piezoelectric actuator, which is represented by the use history of the used head chip 300 or the measurement result of measuring the used head chip 300 itself.
Initial characteristic value: Information related to the ejection performance immediately after the head chip 310 or the used head chip 300 is manufactured, which is represented by information having a correlation with the ejection performance or information for specifying a segment to which the ejection performance belongs.
First ranking: Ranking of the used head chip 300 based on the ejection performance.
Second ranking: Ranking of the used head chip 300 based on the initial characteristic value.

An example of a cycle of manufacturing the head chip 310 and reusing the used head chip 300 will be described with reference to FIG. 8. When the head chip 310 or the liquid ejection apparatus 10 including the head chip 310 is manufactured in the manufacturing process MFG, the product is provided to a market MRT, is collected due to failure, the expiration of the service life, the user's stop of use, or the like, and is reused in a reuse process RCL. In the reuse process RCL, the used head chip 300 is removed or ranked, and further, a second liquid ejection head 31x is manufactured.

In the manufacturing process MFG, first, the head chip 310 is manufactured, the head chip 310 is assembled as the liquid ejection heads 31a and 31b, and further is assembled as the head unit 3, and finally is incorporated in the liquid ejection apparatus 10. In this process, the information such as the initial characteristic value of the head chip 310 and which of the liquid ejection heads 31 the head chip 310 is incorporated in are associated with each other and saved in a database DB1 prepared in the cloud. Each steps from the head chip 310 to the manufacturing of the liquid ejection apparatus 10 may be performed by the same manufacturer, but at least a part of each step may be performed by a manufacturer different from the manufacturer of the head chip 310. Even in the same liquid ejection head 31, the voltage waveform of the drive signal COM for driving the piezoelectric element 60 and the reference voltage Vm may be different depending on the user.

The product such as the liquid ejection apparatus 10 is placed in the market MRT in the form of sales or lease, is withdrawn from the market due to a failure or the expiration of the use period, and is collected in the reuse process RCL. The liquid ejection head in which the collected used head chips 300 are incorporated is illustrated as the first liquid ejection head 31a or the like in the drawing. The used head chip 300 removed from the first liquid ejection head 31a or the like is ranked, and the ranking information is saved in a database DB2. Regarding the ranking, first ranking C1 based on the use history of the used head chip 300 and second ranking C2 based on the initial characteristic value of the used head chip 300 are performed, and the used head chip 300 is classified into ranks R11 to R14 and R21 to R24 obtained by combining these rankings, and ranked.

The ranked used head chip 300 is incorporated as at least a part of the second liquid ejection head 31x. The second liquid ejection head 31x manufactured in this manner is incorporated into the head unit and ultimately the liquid ejection apparatus and is supplied to the market MRT similarly to the head chip 310 in the manufacturing process MFG, or the second liquid ejection head 31x is supplied to the market MRT as a single product.

Since the manufacturing method of the liquid ejection head according to the present embodiment is in the above-described reuse process RCL, the manufacturing of the liquid ejection head in the manufacturing process MFG is not directly involved, but the initial characteristic value of the liquid ejection head may be measured in the manufacturing process MFG, and thus the manufacturing of the liquid ejection head in the manufacturing process MFG will be described in a general manner. In the manufacturing process MFG, first, the head chip 310 is manufactured. A plurality of piezoelectric elements 60 are incorporated in one head chip 310 as actuators for ink ejection. The head chip 310 manufactured in the manufacturing process MFG is classified and ranked in accordance with the measured initial characteristic value after the initial characteristic value is measured. In the present embodiment, the initial characteristic value is the natural vibration cycle Tc of the liquid in the pressure generation chamber 631 of the manufactured head chip 310. Instead of the natural vibration cycle Tc, the natural vibration cycle Tc may be replaced with a volume of the ink droplet ejected when the manufactured head chip 310 is driven by the reference drive signal COM, a weight of the ink droplet, an ejection speed of the ink droplet, or the like.

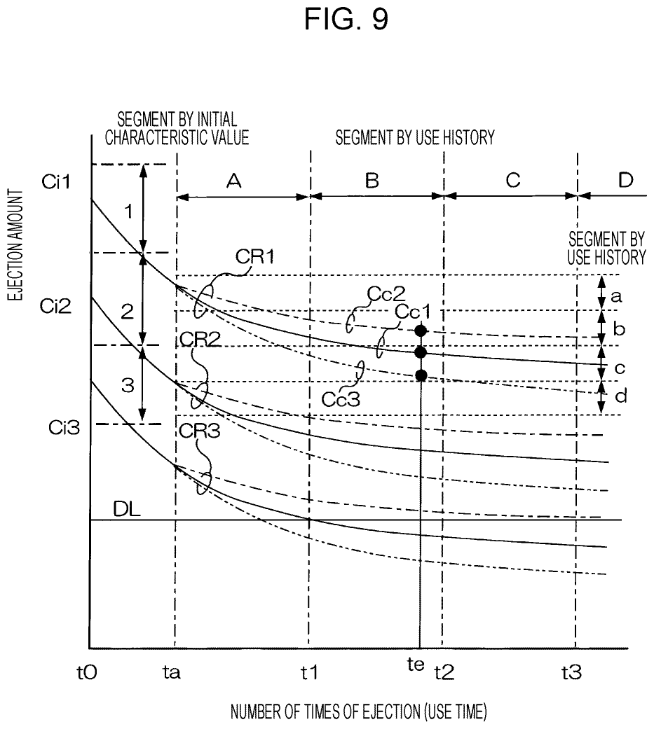

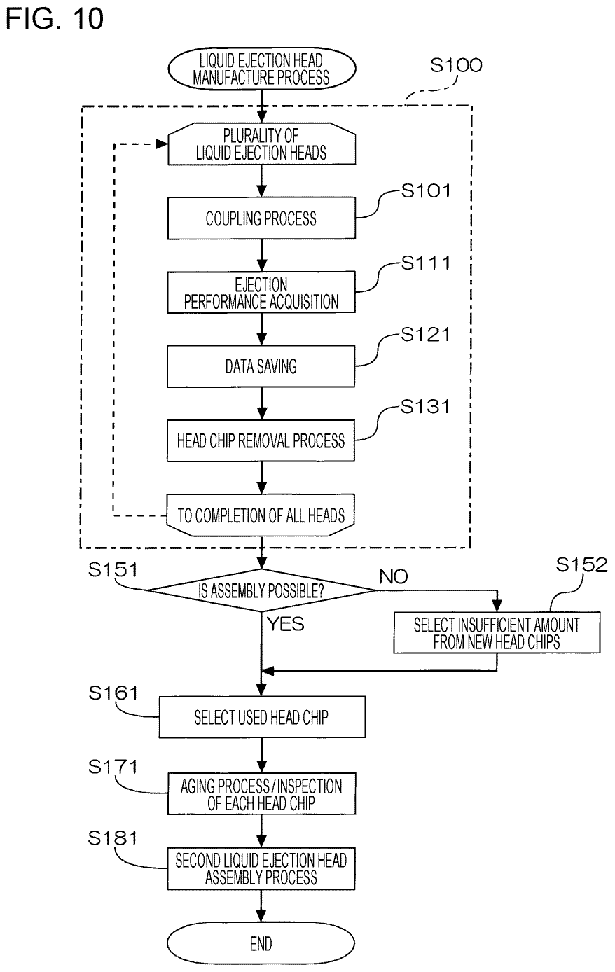

FIG. 9 schematically illustrates the initial characteristic value of the head chip 310 and an aspect of the temporal change of the ejection performance of the head chip 310 thereafter. In the drawing, a vertical axis indicates the ejection performance of the head chip 310, and a horizontal axis indicates the number of times of ejection or the use time of the head chip thereafter. The ejection performance of the head chip 310, in other words, the ejection performance of the piezoelectric element 60 is, for example, the ejection speed or the ink weight of the ink droplet ejected when driving by the natural vibration cycle Tc of the liquid in the pressure generation chamber 631, the reference drive signal COM, or the like, a displacement amount of the diaphragm 621, or the like. The ejection performance of the head chip 310 is correlated with the degree of deterioration of the piezoelectric element 60. The piezoelectric element 60 expands and contracts each time the drive signal COM is applied, and the ejection performance changes in accordance with a cumulative value of the number of times of ejection (hereinafter, referred to as the cumulative number of times of ejection). Therefore, the change in the characteristics due to the use is illustrated depending on the cumulative number of times of ejection, but even when the drive signal COM is not applied, the ejection performance changes as long as the reference voltage Vm is applied to the piezoelectric element 60 regardless of the presence or absence of the ejection of the liquid. Therefore, it is not a problem even when a time during which the drive signal COM and the reference voltage Vm are applied, that is, the use time is treated as being equivalent to the cumulative number of times of ejection.

The drawing is obtained by examining the change in characteristics over a long period of time by keeping the number of times of ejection per unit time constant. Also in the present example, since the reference voltage Vm is applied to the piezoelectric element 60 regardless of the presence or absence of ejection of the liquid, the cumulative number of times of ejection and the use time may be treated as substantially the same as the use history of the head chip. In the drawing, a time t0 indicates a point in time when the head chip 310 is manufactured, and a time ta indicates a timing of the end of an aging period performed when the head chip 310 is manufactured. Since the ejection performance of the head chip 310 greatly changes in the initial use period, the aging process of applying a load for a predetermined time is performed before the actual use. This process will be referred to as an initial aging process. A period of the initial aging process (time t0 to time ta) may be different depending on the magnitude of the initial characteristic value. As illustrated in the drawing, the ejection performance with respect to the drive signal COM is greatly reduced during the initial aging period at the time of manufacturing, and the change in the ejection performance due to the subsequent use is small. The representative characteristics of the head chip 310 are shown as characteristics CR1, CR2, and CR3 in a descending order of the ejection performance Ci1, Ci2, and Ci3 at the point in time when the aging is completed. As a matter of course, the characteristics of the head chip 310 are widely distributed, but for the convenience of understanding, three representative examples in which the ejection performance is large, medium, and small are given.

For the three representative examples, a solid line Cc1, a one-dot chain line Cc2 showing an example of characteristics having higher ejection performance than the solid line Cc1, and a two-dot chain line Cc3 showing an example of characteristics having lower ejection performance than the solid line Cc1 are further drawn. A difference therebetween will be described by taking the characteristics CR1 when the ejection performance corresponding to the initial characteristic value is the highest as an example. In the characteristics CR1, the solid line Cc1 having the time ta when the aging is completed as a start point indicates the change in the ejection performance when an environmental temperature Ta when the head chip 310 is used is assumed to be 25° C. as room temperature, and the reference voltage Vm of the drive signal COM is an average voltage Vav. In addition, the one-dot chain line Cc2 indicates the change in the ejection performance when the environmental temperature Ta when the head chip 310 is used is 15° C. lower than the room temperature, and the reference voltage Vm of the drive signal COM is a voltage Vs lower than the average voltage Vav. Further, the two-dot chain line Cc3 indicates the change in the ejection performance when the environmental temperature Ta when the head chip 310 is used is 45° C. higher than the room temperature, and the reference voltage Vm of the drive signal COM is a voltage V1 higher than the average voltage Vav. Such a change in the characteristics is the same for the characteristics CR2 and the like.

The ejection performance of the head chip 310 varies with the use time as will be described below, but has a strong correlation with the initial characteristic value, which is the ejection performance at the time of manufacturing, as a whole. Therefore, the head chips 310 can be classified and ranked by the initial characteristic value at the time t0 of manufacturing. This corresponds to the second ranking C2, and hereinafter, as necessary, the second ranking C2 will be referred to as ranks 1, 2, and 3. The ranks 1, 2, and 3 are the ejection performance at the time t0 illustrated in FIG. 9, and are included in a range “1”, a range “2”, and a range “3”. As will be described below, the ranking is also performed based on the use history such as the number of times of ejection for the used head chip 300 used as the product in the market, but at the point in time of the manufacturing process MFG, there is no use history other than the aging, and thus the ranking is not performed based on the use history. The ranks A to D and a to d in accordance with the use history described in FIG. 9 will be described in detail below.

The ejection performance of each head chip 310 in the manufacturing process MFG and the aging at the point in time of shipment are described so far, but in general, at the point in time of manufacturing, the head chips 310 belonging to the same rank are collected to manufacture the liquid ejection head 31. This is because the same drive signal COM having the same reference voltage Vm is normally applied to the plurality of head chips 310 included in one liquid ejection head 31. After the manufacturing, the use frequency, the applied voltage, the environmental temperature, and the like of each head chip 310 included in the liquid ejection apparatus 10 placed in the market MRT are diverse, and thus, it is assumed that the ejection performance of each head chip 310 is significantly different at the point in time of collection even though the ejection performance is substantially aligned at the time of manufacturing.

### A5. Manufacture of Second Liquid Ejection Head

Next, a method of recycling each head chip 310 used in the first liquid ejection head 31a and the like collected from the market MRT to manufacture a new liquid ejection head, that is, the second liquid ejection head 31x will be described based on the above-described premise. FIG. 10 is a process view illustrating the manufacturing process of the liquid ejection head according to the first embodiment. The manufacturing of the liquid ejection head according to the first embodiment is the manufacturing in the process illustrated as the reuse process RCL in FIG. 8. At this point in time, the first liquid ejection head 31a and the third liquid ejection head 31b are collected as one or a plurality of liquid ejection heads. When the process of manufacturing the second liquid ejection head 31x, which is a new liquid ejection head, is started, first, an acquisition process (step S100) of acquiring the used head chip from the plurality of liquid ejection heads is performed.

Specifically, in this acquisition process (step S100), in a plurality of target liquid ejection heads, here, the first liquid ejection head 31a and the third liquid ejection head 31b, for each liquid ejection head, a coupling process (step S101), an acquisition process (step S111) of the use history of the used head chip 300, a saving process (step S121) of various data, and a removal process (step S131) of removing the head chip are performed. In the present embodiment, the used head chip 300 removed from the first liquid ejection head 31a corresponds to the first head chip, and the used head chip 300 removed from the third liquid ejection head 31b corresponds to the second head chip.

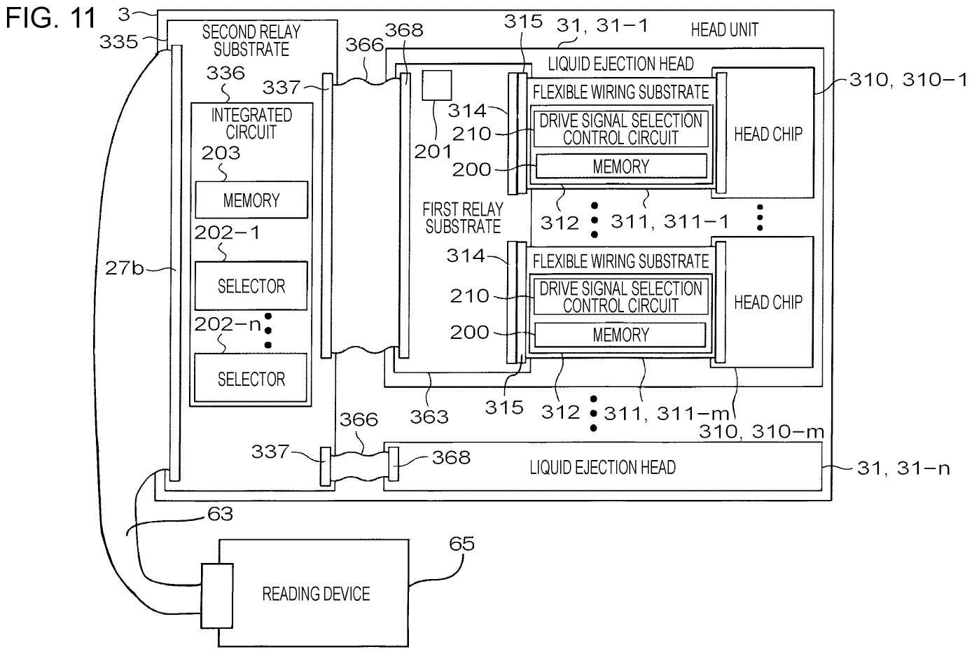

In the coupling process (step S101), the reading device 65 is coupled to the used head chip 300 included in the liquid ejection head 31a or the like treated as the first liquid ejection head so that accessing the memory 200 is enabled. As illustrated in FIG. 11, the coupling of the reading device 65 is performed by, for example, coupling a coupling cable 63 of the reading device 65 to the connector 27b of the second relay substrate 335 of the head unit 3. In this case, the originally coupled cable 17 may be used instead of the coupling cable 63.

In the present embodiment, since the reading device 65 is coupled to the connector 27b of the second relay substrate 335, the use history of each used head chip 300 included in each of all the first liquid ejection heads 31a and the like coupled to the second relay substrate 335 can be read in sequence from each of the memories 200 included in each of the used head chips 300. When the reading device 65 is coupled to the connector 315 of the used head chip 300, the use history of the used head chip 300 can be read in sequence from the memory 200 provided on the flexible wiring substrate 311. The signal and the power necessary to read data such as the use history from the memory 200 are output from the reading device 65 to the second relay substrate 335, the first relay substrate 363, and the flexible wiring substrate 311 via the coupling cable 63.

Instead of the above-described coupling, the coupling cable 63 of the reading device 65 may be coupled to the connector 368 of the first relay substrate 363, and, in this case, the use histories of all the head chips 310-1 to 310-m included in one first liquid ejection head 31a or the like can be read from each memory 200 in sequence.

Further, the reading device 65 may be coupled to the connector 315 provided on the flexible wiring substrate 311 of the used head chip 300 with the coupling cable 63, and the use history may be read for each used head chip 300.

One end of the coupling cable 63 may be provided with a connector that can be coupled to any of the connector 27b, the connector 368, and the connector 315.

When the reading device 65 is coupled, accessing the memory 200 is enabled, and the process of acquiring the ejection performance of each used head chip 300 incorporated in the mounted first liquid ejection head 31a or the like is performed (step S111). In the first embodiment, as the ejection performance, there may be the initial characteristic value of the ejection performance or the use history of the used head chip 300, for example, the cumulative number of times of ejection (hereinafter, also referred to as cumulative number of times of ejection) or the use time associated with a serial number (S/N) of the used head chip 300.

As will be described in a second embodiment, the ejection performance of each used head chip 300 may be treated as a rank specified by the initial characteristic value of the ejection performance, the cumulative number of times of ejection, and the reference voltage Vm, the environmental temperature, and the like, which are the use history. However, in the first embodiment, for convenience of understanding, the ejection performance is described as being acquired from the initial characteristic value and the use time. The initial characteristic value can be acquired with reference to the database DB1 illustrated in FIG. 8 using the serial number S/N of each used head chip 300. In addition, the use time of each used head chip 300 can be read from the memory 200.

As described with reference to FIG. 9, the ejection performance of the head chip 310 is reduced as the head chip 310 is used, so that the ejection performance can be easily acquired based on the initial characteristic value and the use time. As a matter of course, the ejection performance may be directly measured. For example, the displacement amount of the piezoelectric element 60, which is the actuator, in each used head chip 300 may be directly measured and treated as the ejection performance. This is because the amount of the liquid to be ejected is substantially proportional to the displacement amount of the piezoelectric element 60 which is the actuator. The measurement of the displacement amount of the piezoelectric element 60 can be performed by various known methods. For example, the nozzle plate 650 of the liquid ejection head 31 can be used as one of the electrodes for measurement, the voltage change when the charged ink is flown between the two electrodes in a state in which an electric field is formed between the electrode (nozzle plate 650) and the electrode member provided in the capping member of the maintenance mechanism 6 can be detected, and the displacement amount of the piezoelectric element 60 can be estimated based on the magnitude of the voltage. In addition, for example, a method is also known in which a back electromotive force generated when the piezoelectric element 60 is driven is measured and the displacement amount of the piezoelectric element 60 is estimated from the magnitude of the back electromotive force. Any method may be used as long as the displacement amount of the piezoelectric element 60 can be measured.

After the ejection performance of each used head chip 300 is acquired in this way (step S115), the data is saved in a storage device built in the reading device 65 (step S121). This is a process of saving the acquired data related to the ejection performance for the selection of the used head chip 300 to be described below or the aging to be described below. The data may be saved in the storage device prepared in the reading device 65 or may be saved in a storage device prepared in the cloud.

When the acquisition of the ejection performance and the saving of the data are performed for all the used head chips 300 included in one liquid ejection head 31, the process of removing the used head chip 300 is performed (step S131). In the present embodiment, the reading device 65 is coupled to the second relay substrate 335 to collectively perform reading of the data of each used head chip 300, and thus the removal process is performed at the end of the acquisition process (step S100). However, the removal process of the used head chip 300 may be performed first as long as the connector 315 provided on the flexible wiring substrate 311 of each used head chip 300 is coupled to the reading device 65 to read the data.

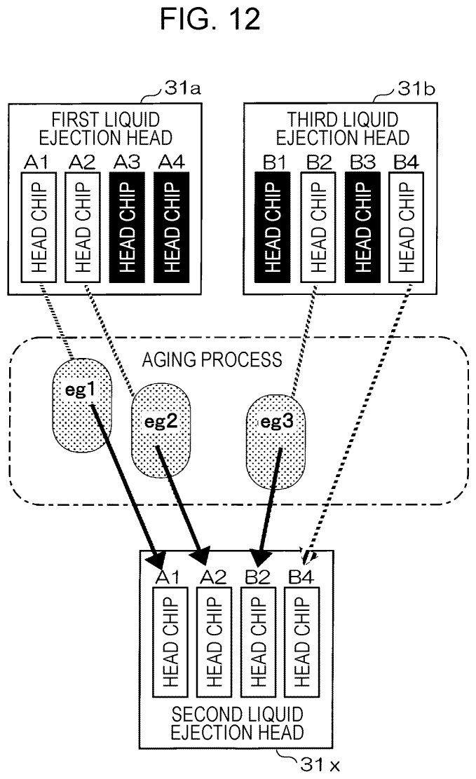

The acquisition process (step S100) is performed for the plurality of target liquid ejection heads 31. When the acquisition process (step S100) for the entire liquid ejection head 31 is completed, the process proceeds to the manufacturing process of the second liquid ejection head 31x after step S151. First, it is determined whether or not the second liquid ejection head 31x, which is a new liquid ejection head, can be assembled by a plurality of removed used head chips 300 (step S151). An example of this step is illustrated in FIG. 12. In this example, the four used head chips 300 are targets of the data acquisition from the first liquid ejection head 31a, and head chips A1 and A2 among the four used head chips 300 are determined to be reusable and are removal targets as the first head chips. In addition, the four used head chips 300 are also targets for the data acquisition from the third liquid ejection head 31b, and head chips B2 and B4 among the four used head chips 300 are determined to be reusable and are removal targets as the second head chips. Head chips A3 and A4, and B1 and B3, which are shown in inverted black and white in the drawing, indicate that the head chips A3 and A4, and B1 and B3 are determined to be unreusable due to insufficient ejection performance or failure. The illustrated aspects are the same in other embodiments. Whether or not the ejection performance is reusable can be determined by whether or not the cumulative value of the number of times of ejection exceeds an upper limit value, whether or not the displacement amount of the piezoelectric element 60 is less than a predetermined value, and the like.

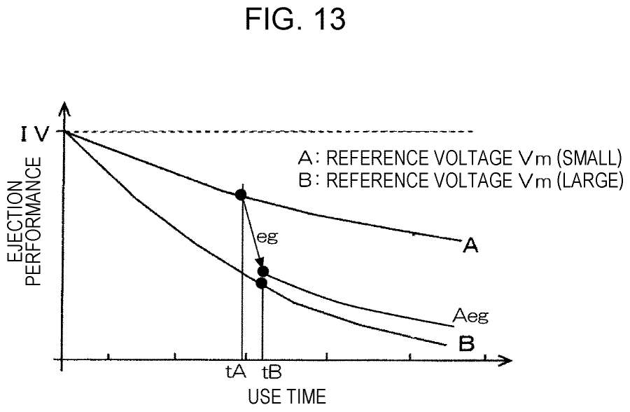

When it is determined that the second liquid ejection head 31x can be assembled only with the used head chip 300 from which the data is acquired, in the determination of step S151 (“YES” in step S151), the reusable first head chip and the second head chip are selected (step S161). Next, the aging process and the inspection of the process result are performed on the selected used head chip 300 (step S171). The aging process is a kind of adjustment process for reducing the variation in the characteristics of the selected head chip, and, particularly, when the actuator is a piezoelectric actuator, the aging process refers to a process of adjusting the ejection performance of the piezoelectric element 60 by applying a predetermined voltage to the piezoelectric element 60 that is directly involved in the ejection performance. In general, the ejection performance is reduced when the aging process is performed. The aspect of the adjustment by the aging will be described with reference to FIG. 13. FIG. 13 collectively illustrates a relationship between the ejection performance and the use time of the first head chips A1 and A2, which are the used head chips 300 removed from the first liquid ejection head 31a, as a solid line A, and a relationship between the ejection performance and the use time of the second head chips B2 and B4, which are the used head chips 300 removed from the third liquid ejection head 31b, as a solid line B. A reference sign IV illustrated in the drawing indicates the initial characteristic value of the ejection performance of each head chip.

In this example, the reference voltage Vm of the drive waveform applied to the used head chip 300 included in the third liquid ejection head 31b is smaller than the reference voltage Vm of the drive waveform applied to the used head chip 300 included in the first liquid ejection head 31a. Therefore, the decrease in the ejection performance of the second head chips B2 and B4, which are the used head chips 300 included in the third liquid ejection head 31b, is greater than the decrease in the ejection performance of the first head chips A1 and A2, which are the used head chips 300 included in the first liquid ejection head 31a. Such differences may be generated not only due to the difference in the reference voltage Vm of the drive waveform but also due to the difference in the use environment temperature between the head chips having the initial characteristic values close to each other.

The first head chips A1 and A2 (the used head chips 300 of the first liquid ejection head 31a) are used until a time tA, and the second head chips B2 and B4 (the used head chips 300 of the third liquid ejection head 31b) are used until a time tB. Therefore, the ejection performance of the first head chips A1 and A2 used until the time tA is significantly higher than the ejection performance of the second head chips B2 and B4 used until the time tB. Therefore, the aging process is performed on the first head chips A1 and A2 having the characteristics of the solid line A in accordance with the difference in the ejection performance. In this example, by performing an aging process eg on the used head chip 300 having the characteristics of the solid line A, the ejection performance of the first head chips A1 and A2 having the characteristics of the solid line A is assumed to have characteristics such as a solid line Aeg, which is substantially the same as the aspect of decrease in the ejection performance of the solid line B, when the first and second head chips A1, A2, B2, and B4 are used at the same reference voltage Vm and the same environmental temperature, after the aging process eg. As a result, in the subsequent use, the ejection performance approaches the ejection performance of the second head chips B2 and B4 having the characteristics of the solid line B, and the difference in the ejection performance of the first and second head chips A1, A2, B2, and B4, here, the difference in the ejection amount is reduced. As illustrated in FIG. 13, in order to reduce the difference in the ejection performance by the short-time aging process eg, it is sufficient to perform at least one of increasing the voltage applied to the piezoelectric actuator when performing the aging process eg, or performing the aging process eg in a state in which the environmental temperature of the used head chip 300 is high.

Whether or not the difference in the ejection performance is reduced is confirmed by an inspection step performed as a part of the aging process. The fact that the difference in the ejection performance is reduced can be confirmed by at least one of the following items.

1. A color difference ΔE of a test image when the same color ink is ejected from each of the first and second head chips A1, A2, B2, and B4 is a predetermined value, for example, a value of 2 or less. It is more preferable to perform the aging process so that the color difference ΔE becomes a value of 1 or less.

2. An ink weight Iw ejected from each of the first and second head chips A1, A2, B2, and B4 is measured, and a difference between the ink weights Iw is reduced as compared with before the aging process.

3. A speed Vs of the ink ejected from each of the first and second head chips A1, A2, B2, and B4 is measured, and a difference between the speeds Vs is reduced as compared with before the aging process.

4. The displacement amounts of the piezoelectric element 60 before and after the aging process are measured or estimated, and the displacement amounts of the piezoelectric element 60 before and after the process are compared, to determine whether or not the difference is reduced. In the above-described 2. to 4. cases, the aging process may be performed for each nozzle.

The reason why the inspection step is also performed as a part of the aging process is that, even when the aging process is performed for a predetermined time, the difference in the ejection performance may not be reduced as small as in the above-described examples. In this case, the inspection is performed to confirm the difference in the ejection performance, and when the difference is not sufficiently small, the aging process is performed again. The aging process need not to be performed for all the used head chips 300, and need only be performed except for the used head chip 300 having the lowest ejection performance. In FIG. 12, the ejection performance of the second head chip B4 in the used head chip 300 is the lowest. In this case, aging processes eg1, eg2, and eg3 are performed on the other first head chips A1 and A2 and the second head chip B2. The step of performing such an aging process corresponds to an adjustment step.

When the aging process is completed and the difference in the ejection performance of the plurality of used head chips 300 is sufficiently small, a process of an assembly step of assembling the second liquid ejection head 31x using these used head chips 300 is performed next (step S181). When the second liquid ejection head 31x is assembled, as the components of the liquid ejection head 31 other than the head chip, a new product may be used or a used product may be reused as long as the used product is usable. Although not illustrated, when the second liquid ejection head 31x is assembled, the second liquid ejection head 31x may be incorporated in a new liquid ejection apparatus 10 such as a printer, and shipped as a product after saving the data indicating the ejection performance of the incorporated head chip in the memory 200.

On the other hand, in the determination of step S151, when it is determined that the assembly of the new second liquid ejection head 31x cannot be performed only with the used head chip 300 removed from the first liquid ejection head 31a and the third liquid ejection head 31b prepared first (step S151: “NO”), the new head chip 310 is selected for the number of the insufficient used head chip 300 in order to supplement the insufficient used head chip 300 (step S152). Then, the remaining head chips are selected from the used head chips 300 (step S161).

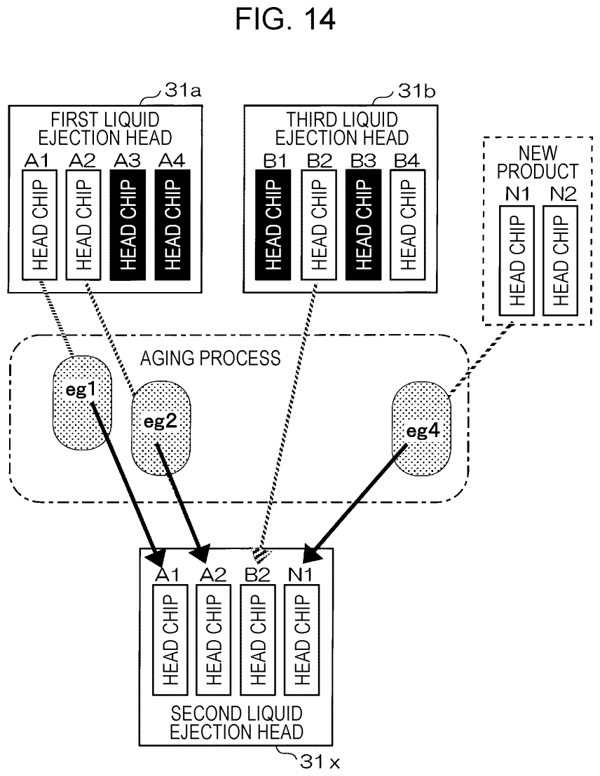

Thereafter, the processes of step S171 and the subsequent steps are performed. This aspect is schematically illustrated in FIG. 14. In this example, among the four head chips of the third liquid ejection head 31b, the head chips other than the head chip B2 are determined to be unusable, and thus only three head chips 300 of the used head chips constituting the second liquid ejection head 31x can be removed from the first liquid ejection head 31a and the third liquid ejection head 31b in total. Therefore, in such a case, the new head chip 310 is used, and the second liquid ejection head 31x is assembled by adding a new head chip N1. In this example, since it is considered that the ejection performance of the head chip N1 is the highest, the aging process eg4 is performed. In the illustrated example, the head chip B2 has the most severe degree of deterioration, that is, the ejection performance is the lowest, and thus the head chip B2 is not subjected to the aging process. The initial aging process described with reference to FIG. 9 for the new head chip N1 is preferably performed before the adjustment step. As a result, the time is shortened as compared with a case in which the initial aging process is performed as a part of the adjustment step.

With the manufacturing method of the liquid ejection head according to the first embodiment described above, the head chip mounted on the first liquid ejection head 31a or the like mounted on the liquid ejection apparatus 10 such as the printer once put on the market can be collected, the state of the collected used head chip 300 can be determined, and the second liquid ejection head 31x, which is a new liquid ejection head, can be manufactured by using the used head chip 300 that is reusable. Therefore, it is not necessary to unnecessarily discard the usable head chip, and resources can be saved. In this case, the reusable used head chip 300 is selected from the initial characteristic value at the time of shipment stored in the memory 200 included in the first liquid ejection head 31a or the like incorporating the used head chip 300 and the use time or the cumulative number of times of ejection due to the use in the market thereafter, the aging process is performed except for the head chip having the lowest ejection performance, the difference in the ejection performance is reduced, and the second liquid ejection head 31x, which is a new liquid ejection head, is assembled. Therefore, it is possible to align the characteristics of the head chips in the newly manufactured second liquid ejection head 31x.

According to the present embodiment, when the used head chip 300 removed from the first liquid ejection head 31a or the like, which is the target of reuse, is insufficient, the new head chip 310 is used, and the new head chip 310 is subjected to the aging process to bring the ejection performance close to the ejection performance of the used head chip 300. Therefore, even in this case, the difference in the characteristics of the head chips constituting the second liquid ejection head 31x can be reduced. Instead of using the new head chip 310, the third liquid ejection head 31c used in another liquid ejection apparatus 10 may be additionally disassembled, the used head chip 300 may be further removed as the second head chip, and the available used head chip 300 may be found and used.

In the above-described embodiment, in addition to the first liquid ejection head 31a, the used head chip 300 is collected from the third liquid ejection head 31b used in another printer and used. However, when only the used head chip 300 collected from the first liquid ejection head 31a is sufficient, the second liquid ejection head 31x may be manufactured without using the third liquid ejection head 31b. Alternatively, when the used head chip 300 is insufficient even by adding the third liquid ejection head 31b, the used head chip 300 obtained by further disassembling the liquid ejection head 31c as the third liquid ejection head 31c may be used.

### B. Second Embodiment

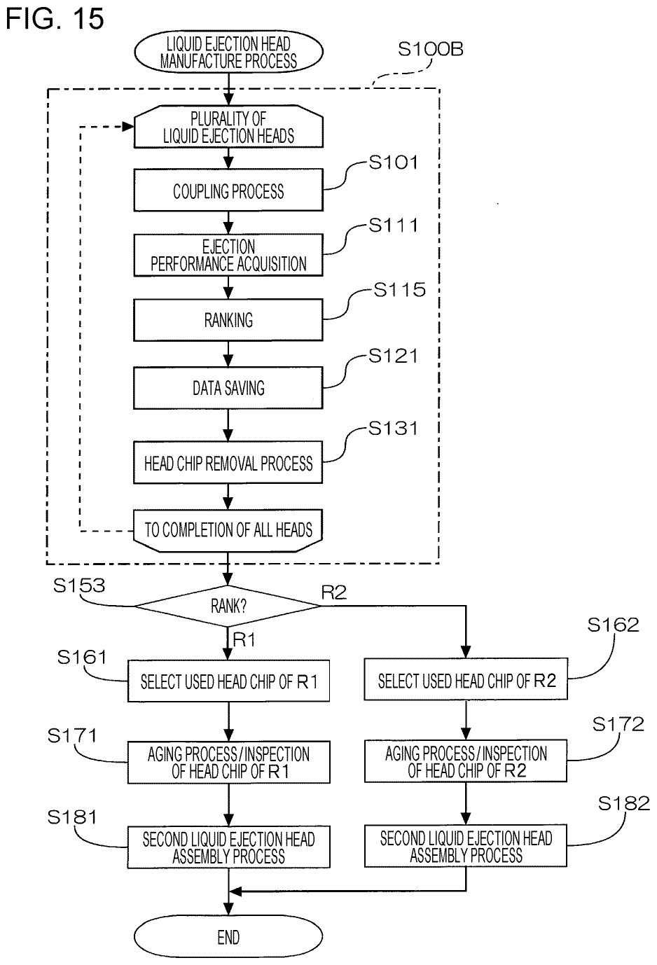

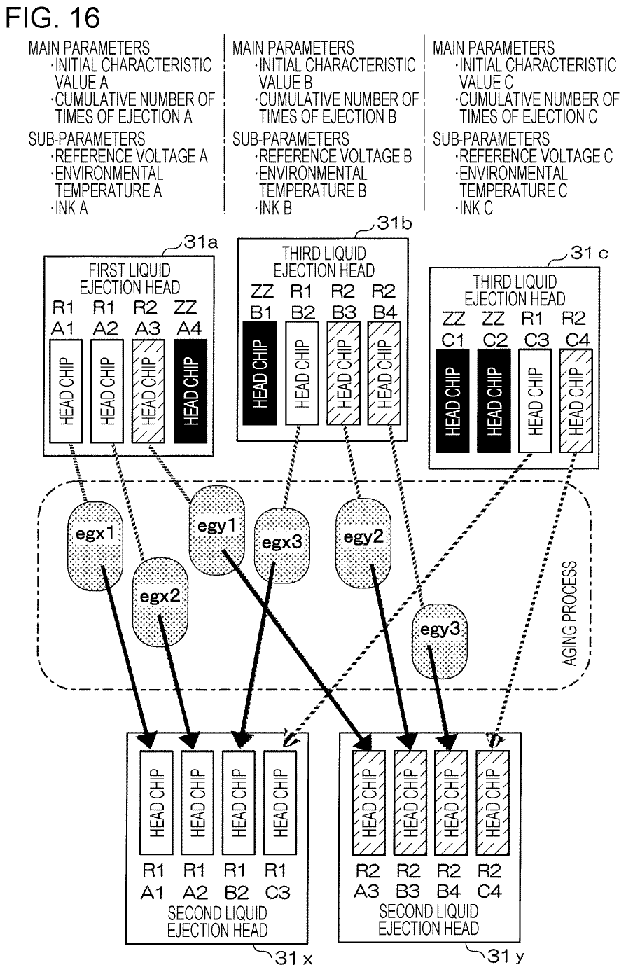

Hereinafter, a manufacturing method of a liquid ejection head according to the second embodiment will be described. The steps of the manufacturing method according to the second embodiment are illustrated in FIG. 15. In addition, an aspect of manufacturing the liquid ejection head in this case is schematically illustrated in FIG. 16. In the second embodiment, for manufacturing the liquid ejection head, the used head chip 300 is removed from the liquid ejection apparatus 10 in the same manner as in the first embodiment in a state in which the first liquid ejection head 31a and the third liquid ejection heads 31b and 31c are prepared, and a new liquid ejection head is manufactured. In the second embodiment, the removed used head chips 300 are ranked, and the second liquid ejection heads 31x and 31y, which are new liquid ejection heads, are manufactured based on the rank.

When the manufacturing process is started, first, an acquisition process (step S100B) is performed. The acquisition process according to the second embodiment is different from the acquisition process according to the first embodiment in that a process of ranking (step S115) is added after the process (step S111) of reading the data such as the number of times of ejection from the first liquid ejection head 31a or the third liquid ejection heads 31b and 31c. In the ranking process, the used head chip 300 is classified into any of several ranks. In the present embodiment, as illustrated in the uppermost part of FIG. 16, the classification is made using the initial characteristic value and the cumulative number of times of ejection as the main parameters, and the reference voltage Vm of the drive signal COM, the environmental temperature of the used head chip 300, and the type of ink ejected by the used head chip 300 as the sub-parameters. As a result, the rank is used to classify the used head chip 300 in accordance with the degree of deterioration of the piezoelectric actuator. The main parameters and the sub-parameters necessary for such ranking are read from the first liquid ejection head 31a in step S111, or are read via the database DB1 from the serial number (S/N) of the used head chip 300.

Step S115 of the ranking will be described. The first ranking C1 and the second ranking C2 are performed first using the main parameters. The cumulative number of times of ejection is used as the use history, and the first ranking C1 is performed based on the cumulative number of times of ejection belonging to any one of the segments A to D illustrated in FIG. 9. In addition, the second ranking C2 is performed by determining to which of the segment 1 or 2 of the initial characteristic value illustrated in FIG. 9 the ejection performance immediately after the manufacturing of each used head chip 300 belongs. Although the drawing also illustrates the segment 3 as the initial characteristic value segment, the head chip 310 having the initial characteristic value in the segment 3 is not used in the manufacturing of the entire liquid ejection head 31 as an initial defective product having low ejection performance from the beginning, and thus, in the second ranking C2, the used head chip 300 is ranked in the segment 1 or the segment 2.

By combining the first ranking C1 and the second ranking C2 in this manner, the used head chip 300 can be classified into any of the total of eight ranks of ranks R11 to R14 and ranks R21 to R24 by the cumulative number of times of ejection (four segments of A to D) and the initial characteristic value (two segments of 1 and 2).

In the above description of the ranking, the first ranking C1 that is ranking based on the use history and the second ranking C2 that is ranking based on the initial characteristic value are described as being performed independently of each other, but both of the first ranking C1 and the second ranking C2 can be combined to perform the ranking further by taking the sub-parameters into account. The method will be described below.

As illustrated in FIG. 9, the ejection performance of the head chip after a predetermined aging is performed changes with the increase in the number of times of ejection, but the degree of change is affected by a difference in the environmental temperature, the reference voltage Vm of the drive signal COM, or the like. Regarding the used head chip 300, the initial characteristic value and the change in ejection performance due to subsequent use are examined for each parameter that affects the ejection performance, such as the environmental temperature and the reference voltage Vm of the drive signal COM. Therefore, when the initial characteristic value and the parameter are known, it is possible to assume with high accuracy how the ejection performance changes with the increase in the number of times of ejection. Therefore, as illustrated in FIG. 9, when the segments of the ejection performance, such as the ranges a, b, c, and d, are assumed based on the initial characteristic value and the various parameters with reference to the ejection performance implemented by aging, the rank of the used head chip 300 at a certain point in time in the number of times of ejection can be further subdivided and known. This corresponds to ranking the used head chip 300 in accordance with the use history for each initial characteristic value, that is, in combination of the initial characteristic value and the use history.

For example, when the head chip 310 having the ejection performance as the initial characteristic value of Ci1 is used at the environmental temperature of 15° C. and the reference voltage Vm of the voltage Vs, the rank of the use history of the used head chip 300 at the ejection time te is the rank b based on the one-dot chain line Cc2 in the drawing. Similarly, when the used head chip 300 having the ejection performance as the initial characteristic value of Ci1 is used at the environmental temperature of 25° C. and the reference voltage Vm of the voltage VAV, the rank of the head chip at the ejection time te based on the use history is the rank c based on the solid line Cc1 illustrated in the drawing. When the environmental temperature is 45° C. and the reference voltage Vm is used at the voltage V1, the rank of the use history of the used head chip 300 at the ejection time te is rank d based on the two-dot chain line Cc3. Here, the rank d is a reuse-impossible rank exceeding a use limit, and the used head chip 300 of the segment d may be excluded from a target of a selection step.

As the use history to be combined with such initial characteristic values, representative parameters are described as follows. These parameters correlate with the degree of deterioration of the piezoelectric element 60.
Cumulative number of times of ejection (use time): The cumulative number of times of ejection is one of the main parameters, and the influence on the ejection performance is described in detail above, so that the description thereof will be omitted here. The first ranking C1 regarding the degree of deterioration of the piezoelectric element 60 may be performed based only on the cumulative number of times of ejection (use time) without using the use history such as the use environment temperature and the reference voltage Vm. In this case, the first ranking C1 classifies the used head chips 300 into ranks A to D. The ranking according to the first embodiment is performed based only on the cumulative number of times of ejection (use time), and the used head chips 300 are classified into the ranks A to D.
Use environment temperature: The temperature when the used head chip 300 is used, and is treated as a sub-parameter. The environmental temperature when the used head chip 300 is used is not always the same, but an average temperature may be obtained as the environmental temperature, or the environmental temperature may be obtained for each use time, and a value obtained by accumulating the environmental temperature may be treated as the parameter of the environmental temperature. That is, the first ranking C1 regarding the degree of deterioration of the piezoelectric element 60 may be used in combination with the cumulative number of times of ejection (use time) together with the reference voltage Vm to classify the used head chip 300 into the ranks a to d. The used head chip 300 may be classified into the ranks a to d by combining only the cumulative number of times of ejection (use time) and the use environment temperature without using reference voltage Vm.
Reference voltage Vm: A potential difference from the reference potential Vbs of the drive signal COM applied to the used head chip 300 to the intermediate potential Vc, which is also treated as one of the sub-parameters. The voltage value itself may be used, or the voltage value may be divided into a plurality of segments, and the segment to which the reference voltage Vm belongs may be used. That is, the first ranking C1 regarding the degree of deterioration of the piezoelectric element 60 may be used in combination with the cumulative number of times of ejection (use time) together with the use environment temperature to classify the used head chip 300 into the ranks a to d. The used head chip 300 may be classified into the ranks a to d by combining only the cumulative number of times of ejection (use time) and the reference voltage Vm without using use environment temperature.
Ink type: As the viscosity of the ink to be ejected is higher, the reference voltage Vm of the drive waveform to be applied to the piezoelectric actuator for ejection is higher, and the piezoelectric actuator is more likely to deteriorate. In addition, when an ink for performing a solid printing (solid ejection) with a high operating rate (duty), such as a black ink, a white ink, a pre-treatment liquid, or a post-treatment liquid such as an overcoat for treating a medium surface in advance, it is necessary to increase the amount of ink ejected from the nozzle 651, and in this case, the reference voltage Vm applied to the piezoelectric actuator for ejecting these inks tends to increase. That is, the reference voltage Vm may be estimated depending on the type of ink.

The ranks a to d are provided for each of the ranks 1 and 2 of the initial characteristic value.

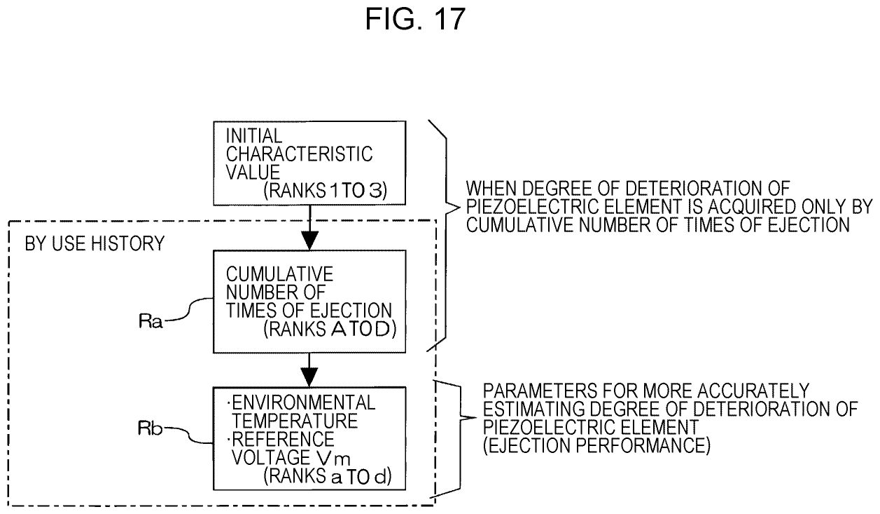

FIG. 17 illustrates an example of a priority of the ranking of combining the use history and the initial characteristic value. In the illustrated example, the ranking processes Ra and Rb described below are performed as the first ranking based on the use history in addition to the second ranking process based on the initial characteristic value (ranks 1 to 3 in FIG. 9).

Process Ra: Ranking process based on the cumulative number of times of ejection (ranks A to D in FIG. 9)

Process Rb: Ranking process based on the environmental temperature and the reference voltage Vm (ranks a to d in FIG. 9)

It is desirable to exclude the used head chips 300, which are classified as “reuse-impossible rank ZZ” as being unable to withstand continued use in any of processes Ra and Rb in the first ranking process based on these usage histories, from the targets of reuse. All of these use history parameters may be taken into account, or some of the use history parameters may be taken into account.

The parameters related to the use history, that is, the use histories such as the cumulative number of times of ejection that increases by the use, the environmental temperature at the time of the use, and the reference voltage Vm are counted by the control circuit 71 of the drive circuit substrate 7, and are written at any time in the memory 200 provided in each head chip 310 via the second relay substrate 335 and the first relay substrate 363. As described above, the cumulative number of times of ejection may be replaced with the use time of the head chip 310 or the liquid ejection head 31a, or the like.

By such a process, as illustrated in FIG. 16, the acquisition process (step S100B) is performed on the first liquid ejection head 31a and the third liquid ejection heads 31b and 31c, the ranking is performed, and then a total of 12 used head chips 300 are removed. Although the actual ranking is wide-ranging as illustrated in FIG. 17, here, the result of the ranking performed using the above-described parameters is simplified and illustrated as the rank R1, rank R2, and rank ZZ. The rank R2 has a higher degree of deterioration of the piezoelectric actuator than the rank R1. Therefore, in the present embodiment, the first head chips A1 and A2, which are the used head chips 300 removed from the first liquid ejection head 31a, and the first head chips B2 and C3, which are the used head chips 300 removed from the third liquid ejection heads 31b and 31c, are the head chips of the rank R1. On the other hand, the third head chip A3, the third head chip B3, B4, and C4, which are the used head chips 300 removed from the first liquid ejection head 31a, and the third liquid ejection heads 31b and 31c, which are the used head chips 300 removed from the third liquid ejection heads 31b and 31c, are the head chips of the rank R2. As a result, in this example, as illustrated in the uppermost part in the drawing, the first head chips A1, A2, B2, and C3 which are the used head chips 300 of the rank R1, the third head chips A3, B3, B4, and C4 which are the used head chips 300 of the rank R2, and the head chips A4, B1, C1, and C2 which are the head chips 300 of the rank ZZ, that is, which cannot be reusable, are obtained. In the drawing, the head chip of the rank R1 is shown as it is, the head chip of the rank R2 is shown with hatching of oblique lines, and the head chip outside the rank is shown in a state of black and white inversion.

Returning to FIG. 15, in the manufacturing method of the liquid ejection head according to the second embodiment, after the acquisition process (step S100B) for all the target liquid ejection heads, with respect to the plurality of removed used head chips 300, the ranks of the plurality of removed used head chips 300 are examined (step S153), only the used head chips 300 having the rank R1 or the rank R2 are selected (step S161 or S162), and the aging process and the subsequent inspection are performed on the four used head chips 300 having the rank R1 or the rank R2 that constitute the new second liquid ejection head 31x or 31y, except for the one having the highest degree of deterioration (step S171 or S172). Here, as illustrated in the middle part of FIG. 16, the head chips C3 and C4 are not subjected to the aging process, and the other head chips are subjected to the aging process. The setting of the degree of aging, the inspection of the adjustment of the ejection performance due to the aging, and the like are the same as those in the first embodiment. By repeating the aging process and the inspection when necessary, the ejection performance of each head chip is within a predetermined range. Therefore, thereafter, the process of assembling the second liquid ejection head 31x from only the first head chips A1, A2, B2, and C3 of the rank R1 or the process of the assembly step of assembling the second liquid ejection head 40y from only the third head chips A3, B3, B4, and C4 of the rank R2 (steps S181 or S182) is performed, and the present process step ends. It is the same as in the first embodiment that, when the second liquid ejection heads 31x and 31y are assembled, data indicating the ejection performance of the incorporated head chip is saved in the memory 200, or the second liquid ejection heads 31x and 31y are incorporated in the new liquid ejection apparatus 10 and shipped as the product.

With the manufacturing method according to the second embodiment described above, the used head chips 300 collected from the first liquid ejection head 31a and the third liquid ejection heads 31b and 31c included in the plurality of liquid ejection apparatuses 10 are ranked into a plurality of the ranks, only the used head chips 300 of the rank R1 are collected to manufacture the second liquid ejection head 31x, and only the used head chips 300 of the rank R2 are collected to manufacture the second liquid ejection head 31y. Moreover, the used head chip 300 of the same rank is subjected to the aging process, and the ejection performance of the used head chip 300 incorporated in each of the second liquid ejection heads 31x and 31y is brought close to each other. That is, the aging process is performed as the adjustment process on the used head chip 300 having the relatively close ejection performance, so that the time for performing the aging process in the adjustment process can be shortened. In the first embodiment, as described with reference to FIG. 13, the degree of aging need only be determined such that the difference from the ejection performance of the used head chip 300 having the lowest ejection performance is reduced and the ejection performances approach each other. Therefore, the ejection performance of the used head chips 300 installed in each of the second liquid ejection heads 31x and 31y can be aligned in a predetermined range.

### C. Third Embodiment

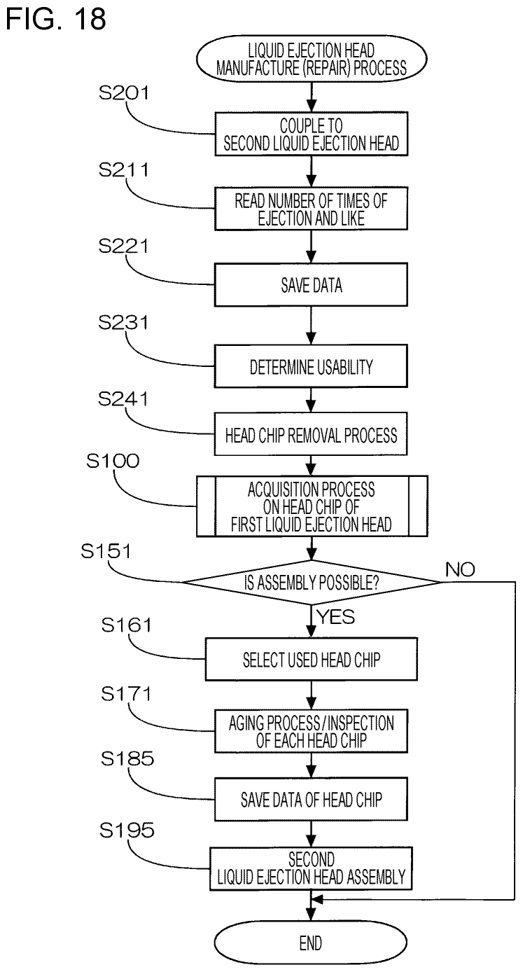

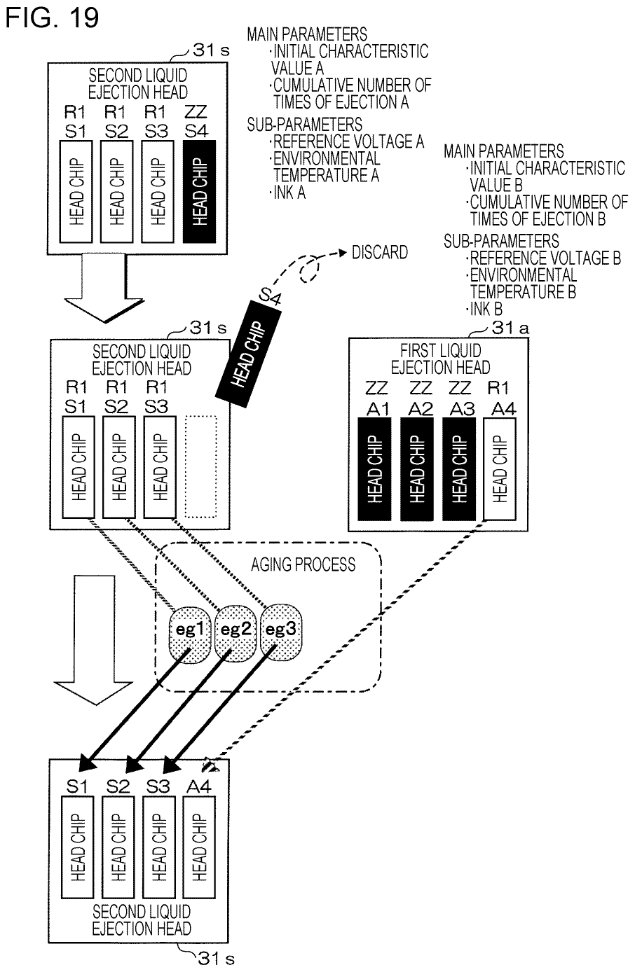

Hereinafter, a manufacturing method of a liquid ejection head according to a third embodiment will be described. The steps of the manufacturing method according to the third embodiment are illustrated in FIG. 18. In addition, an aspect of manufacturing the liquid ejection head in this case is schematically illustrated in FIG. 19. In the third embodiment, in order to repair or manufacture the second liquid ejection head 31s, the work is started in a state in which one first liquid ejection head 31a is prepared in addition to the second liquid ejection head 31s. When the process is started, first, a coupling process (step S201), a read process (step S211), a data saving process (step S221), a usability determination (step S231), and a head chip removal process (step S241) are performed on the second liquid ejection head 31s that is a repair target.

The coupling process (step S201) is a process of coupling the reading device 65 to the connector 27b of the second relay substrate 335 as illustrated in FIG. 11. The subsequent data read process (step S211) is a process of reading data representing the state of each head chip 310 included in the second liquid ejection head 31s, such as the cumulative value of the number of times of ejection, the initial characteristic value, and the like, by the reading device 65. Since these data are recorded in the memory 200 of the second liquid ejection head 31s, it is easy to couple the reading device 65 and read the data before removing the second liquid ejection head 31a or the like. The data saving process (step S221) is a process of saving the read data for the selection of the used head chip 300 to be described below, which is included in the first liquid ejection head 31a. The data may be saved in the storage device prepared in the reading device 65 or may be saved in the storage device prepared in the cloud.

The usability determination (step S231) is a step of determining whether or not each head chip 310 included in the second liquid ejection head 31s is a head chip that can be continuously used, based on the data read from the memory 200. In the second liquid ejection head 31s illustrated in FIG. 19, as illustrated at the uppermost part of the drawing, the main parameters and the sub-parameters are read, and the rank including the unusable rank ZZ is determined based on these parameters. The method of determining the rank from the main parameter and the sub-parameter is the same as the method according to the second embodiment. Among the four head chips S1 to S4 of the second liquid ejection head 31s, the head chips S1 to S3 are determined to belong to the rank R1, and the head chip S4 is determined to belong to the rank ZZ, that is, to be unusable. The head chips S1 to S3 correspond to the second head chip. Whether or not the head chip S4 is unusable may be determined in accordance with the characteristic view illustrated in FIG. 9 from the initial characteristic value and the cumulative number of times of ejection, or the liquid ejection apparatus 10 equipped with the second liquid ejection head 31s may perform the dot missing inspection, determine that the head chip that does not eject ink even when the cleaning or the like is performed is “failure”, write the determination result in the memory 203 of the second relay substrate 335, and read the determination result from the memory 203 to perform the determination. As a matter of course, such “failure” data may be written in the first relay substrate 363 in step S201 or in the memory 200 provided corresponding to each head chip and may be used.

Then, the removal process (step S241) of removing the head chip S4 determined to be unusable is performed. This aspect is illustrated in the middle part of FIG. 19. The extracted head chip S4 is discarded. The above process is a process of acquiring the state of the second liquid ejection head 31s necessary when the second liquid ejection head 31s is repaired, and specifying the second head chips S1 to S3.

Hereinafter, the acquisition process (step S100) for the first liquid ejection head 31a is performed. This process is the same as the acquisition process according to the first embodiment. As a result, the used head chip 300 corresponding to the first head chip is specified and removed from the first liquid ejection head 31a. Then, based on the state of each head chip 310 obtained in the acquisition process (step S100), it is determined whether or not the assembly for repairing the second liquid ejection head 31s can be performed (step S151). In the example illustrated in FIG. 19, the main parameters and the sub-parameters for each of the used head chips 300 of the first liquid ejection head 31a are read, and the rank of the used head chip 300 is determined based on the main parameters and the sub-parameters. In this example, among the four used head chips 300 included in the first liquid ejection head 31a, the head chips A1 to A3 belong to the rank ZZ and are determined to be unusable, but the head chip A4 belongs to the rank R1 and is determined to be the first head chip that can be reused.

When it is determined that the repair and assembly of the second liquid ejection head 31s can be performed only with the used head chip 300 from which the data is acquired, in the determination of step S151 (“YES” in step S151), a plurality of reusable head chips may be found, and thus the process of selecting one of the plurality of head chips is performed (step S161). In this case, as illustrated in FIG. 19, the first head chip A4 included in the first liquid ejection head 31a is selected. Next, a process (step S165) of assembling the selected head chip to the second liquid ejection head 31s is performed, and the selected first head chip A4 and the second head chips S1 to S3 that are present in the second liquid ejection head 31s are installed to constitute the second liquid ejection head 31s. The aging process and the inspection of the process result are performed on the necessary used head chips 300 among the four used head chips 300 constituting the second liquid ejection head 31s (step S171). In the third embodiment, the used head chip 300 removed from the first liquid ejection head 31a corresponds to the first head chip, and the head chip not removed from the second liquid ejection head 31s corresponds to the second head chip. The aging process is a kind of adjustment for reducing the variation in the characteristics of the used head chip 300, which is the same as in the other embodiments. In the example illustrated in FIG. 19, it is determined that the head chip A4 has the lowest degree of deterioration, and the aging processes es1 to es3 are performed on the head chips S1 to S3 excluding the head chip A4.

When the difference in the ejection performance of the plurality of used head chips 300 is sufficiently small as a result of the aging process, the repair of the second liquid ejection head 31s is assumed to be completed next, and then, the process (step S185) of saving the data of the used head chips 300 constituting the second liquid ejection head 31s in the memory 200 or the like is performed, and then, the process (step S195) of the assembly step of assembling the second liquid ejection head 31s is performed, and the present manufacturing process ends by exiting to “END”. When it is determined in the determination in step S151 that the assembly of the second liquid ejection head 31s cannot be performed with the used head chip 300 included in the first liquid ejection head 31a and the second liquid ejection head 31s, the assembly of the second liquid ejection head 31s is not performed, and the process ends by exiting to “END”. As a matter of course, when it is determined that the used head chips 300 of the first liquid ejection head 31a and the second liquid ejection head 31s cannot be assembled to the second liquid ejection head 31s, the selection of the used head chip 300 that can be used from the third liquid ejection head 31b or the like may be added.

With the manufacturing method according to the third embodiment described above, when one or some of the head chips 310 included in the second liquid ejection head 31s fail, the used head chip 300 used in the first liquid ejection head 31a with the use history can be repaired by using the used head chip 300. Also in this case, it is not necessary to discard the second liquid ejection head 31s in which only one or some of the head chips 310 fail. It is not necessary to use a new head chip for repair, which contributes to resource saving. Further, since the aging process is performed, it is possible to suppress the variation in the ejection performance of the used head chip 300 in the second liquid ejection head 31s.

In the third embodiment described above, the used head chip 300 used for repairing the failed second liquid ejection head 31s is removed only from the first liquid ejection head 31a, but the used head chip 300 used for in the liquid ejection head 31 different from the first liquid ejection head 31a, such as the third liquid ejection head 31b, may be used together.

### D. Other Embodiments

1. The present disclosure can be implemented in the following embodiment. One of the manufacturing method of a liquid ejection head that can be implemented is a manufacturing method of a liquid ejection head that is a method for reusing a first head chip of a first liquid ejection head to manufacture a second liquid ejection head including the first head chip and a second head chip different from a head chip incorporated in the first liquid ejection head, the first head chip and the second head chip each including an actuator that is driven for liquid ejection, the manufacturing method including: a removal step of removing the first head chip from the first liquid ejection head; an assembly step of incorporating the first head chip into the second liquid ejection head; and an adjustment step of performing an adjustment process of reducing a difference between ejection performance of the first head chip and ejection performance of the second head chip, on the actuator of at least one of the first head chip or the second head chip. In this way, when manufacturing the liquid ejection head, the second liquid ejection head can be manufactured by reusing the first head chip included in the first liquid ejection head, and the difference in the ejection performance of the head chips can be reduced. Therefore, the variation in the ejection performance of the manufactured second liquid ejection head can be reduced.

The result of the adjustment process of reducing the difference in the ejection performance of the head chips of the second liquid ejection head may be confirmed by the inspection step or the like, or whether or not the difference in the ejection performance is reduced may be determined by estimating the displacement amount before the adjustment process based on the use history, and comparing the estimated current displacement amount with the current displacement amount estimated by taking the current displacement amount or the history of the adjustment process into account. It is desirable that whether or not the difference in the ejection performance is reduced is determined based on the fact that the color difference (ΔE) with the test image when the ink of the same color is ejected is a value of 2 or less, and preferably a value of 1 or less. Alternatively, the determination may be performed based on the fact that the ejected ink weight is smaller than the ejected ink weight before the adjustment process, or the fact that the ejection speed of the ink to be ejected is smaller than the ejection speed before the adjustment process.

The adjustment process may be performed on all of the first head chips or the second head chips, or all of the head chips included in the second liquid ejection head, but need only be performed on at least one head chip when the difference in the ejection performance can be reduced. When the adjustment process causes the decrease in the ejection performance as in the aging process, the adjustment process need only be performed on the head chips other than the head chip having the lowest ejection performance. When the adjustment process can recover the ejection performance, the adjustment process need only be performed on the head chips excluding the head chip having the highest ejection performance. For example, when the actuator uses an electrostrictive element and the element can recover its deformation amount by applying a voltage opposite in polarity to the voltage applied during ejection, such adjustment process need only be performed to reduce the differences in ejection performance. The adjustment process does not include replacement of a drive element such as a piezoelectric element in the actuator.

The manufacturing method can be applied to manufacturing of a liquid ejection head that ejects various types of liquid such as ink, water, alcohol, liquid fuel, and chemical liquid. The ejection performance of the first and second head chips may be grasped with reference to the use history of each head chip, or may be acquired by extracting the first and second head chips, attaching the first and second head chips to a measurement device, and measuring the ejection performance.

2. In the above-described configuration, the removal step may include removing the second head chip from a third liquid ejection head different from the first liquid ejection head and the second liquid ejection head, and the assembly step may include incorporating the second head chip into the second liquid ejection head. In this way, the second liquid ejection head can be manufactured by using at least two head chips from different liquid ejection heads. For example, when the number of head chips that can be removed from the first liquid ejection head for reuse is less than the number of head chips necessary for the second liquid ejection head, the second liquid ejection head can be manufactured by using the third liquid ejection head. Alternatively, even when the number of head chips of the second liquid ejection head is larger than the number of head chips of the first liquid ejection head, for example, although the same head chip is used, the second liquid ejection head can be manufactured by using the third liquid ejection head.

As a matter of course, the use of the third liquid ejection head is not essential, and the second liquid ejection head can be manufactured without using the third liquid ejection head when the number of head chips that can be removed from the first liquid ejection head for reuse is equal to or larger than the number of head chips necessary for the second liquid ejection head. Such a case may occur, for example, when the first liquid ejection head and the second liquid ejection head use the same head chip, and the number of head chips included in the first liquid ejection head is larger than the number of head chips of the second liquid ejection head.

3. In the above-described configuration, the actuator may be a piezoelectric actuator, and the adjustment process may be a process of performing aging on the piezoelectric actuator of at least one of the first head chip or the second head chip. As described above, it is possible to easily adjust the ejection performance of the head chip using the piezoelectric actuator as the actuator.

4. In the above-described configuration, the removal step may include removing the second head chip from a third liquid ejection head different from the first liquid ejection head and the second liquid ejection head, the assembly step may include incorporating the second head chip into the second liquid ejection head, and the adjustment step may include setting a condition of the aging process performed on the at least one of the first head chip or the second head chip based on a reference voltage of a drive waveform applied to the piezoelectric actuator of the first head chip as a part of the first liquid ejection head before the removal step and a reference voltage of a drive waveform applied to the piezoelectric actuator of the second head chip as a part of the third liquid ejection head before the removal step. In this manner, even when the drive waveform applied to the piezoelectric actuator of the first head chip before the removal step and the drive waveform applied to the piezoelectric actuator of the second head chip as a part of the third liquid ejection head before the removal step are different from each other, that is, for head chips collected from at least two different liquid ejection heads that are used with different drive waveforms, the adjustment process can be performed by changing the reference voltage without changing the drive waveform itself. As a matter of course, the adjustment process may be performed by changing the drive waveform itself.

In the adjustment process, in order to reduce the difference in the ejection performance between the first head chip and the second head chip assembled as the second liquid ejection head, normally, the degree of deterioration of the head chip is known, the degree of deterioration of one head chip is modified, and the difference therebetween is reduced.

Further, the sub-parameters that secondarily contribute to the degree of deterioration of the head chip include the following items. Such sub-parameters greatly differ depending on the user who uses the liquid ejection head, that is, the use environment of the liquid ejection head, including the configuration of the liquid ejection apparatus and the type of liquid to be ejected.
Drive waveform: Since the piezoelectric actuator is applied with an intermediate potential at the time of non-ejection, it is known that, as the potential difference between the intermediate potential of the individual electrode and the potential of the common electrode is larger, the piezoelectric actuator is more likely to deteriorate.
Environmental temperature: It is known that the piezoelectric actuator is more likely to deteriorate as the environmental temperature is higher.
Type of liquid: It is known that, as the viscosity of the liquid to be ejected is higher, more energy is consumed by the piezoelectric actuator, and thus the piezoelectric actuator is more likely to deteriorate. As the viscosity of the liquid is higher, the drive voltage to be applied to the piezoelectric actuator for ejection is higher, and the piezoelectric actuator is more likely to deteriorate. When ink in which liquid is ejected onto the medium, when a pre-treatment liquid applied to the medium before the ink is ejected or a post-treatment liquid applied to the medium after the ink is ejected, it is necessary to increase the amount of the liquid to be ejected, and there is a tendency that the reference voltage applied to the piezoelectric actuator that ejects these liquids increases.

The adjustment process for reducing the difference in the ejection performance between the first head chip and the second head chip is performed by setting conditions such as the size of the drive waveform, the number of times of ejection, and the environmental temperature when the adjustment process is performed. Here, the magnitude of the drive waveform can be treated as the magnitude of the intermediate potential, and the displacement amount of the piezoelectric actuator can be adjusted by changing the intermediate potential, thereby setting the condition of the adjustment process. As a matter of course, the condition of the adjustment process can be set even when the number of times of ejection or the energization time is changed, and can be set in accordance with the environmental temperature of the head chip when the adjustment process is performed. The adjustment process may be performed for each nozzle when the piezoelectric actuator is provided for each of the plurality of liquid ejection nozzles provided in the head chip. However, when the wiring to the plurality of piezoelectric actuators is commonly used for simplifying the wiring for the coupling, it is considered that the degree of deterioration is not different or small between the plurality of piezoelectric actuators, so that the adjustment process may be performed for each head chip. When the intermediate potential of the drive waveform enters all the piezoelectric actuators provided for each nozzle, the use time for each piezoelectric actuator is the same, and the difference in the degree of deterioration in the head chip can be considered to be sufficiently small.

5. In the above-described configuration, the removal step may include removing the second head chip from a third liquid ejection head different from the first liquid ejection head and the second liquid ejection head, the assembly step may include incorporating the second head chip into the second liquid ejection head, and the adjustment step may include setting a condition of the aging process performed on the at least one of the first head chip or the second head chip based on an environmental temperature when the first liquid ejection head is used before the removal step and an environmental temperature when the third liquid ejection head is used before the removal step. In this way, the adjustment process can be performed in accordance with the environmental temperature when the head chip is used in the liquid ejection head, and the difference in the ejection performance of the first and second head chips can be reduced as described above.

6. In the above-described configuration, the removal step may include removing the second head chip from a third liquid ejection head different from the first liquid ejection head and the second liquid ejection head, the assembly step may include incorporating the second head chip into the second liquid ejection head, and the adjustment step may include setting a condition of the aging process performed on the at least one of the first head chip or the second head chip based on a type of liquid supplied to the first head chip as a part of the first liquid ejection head before the removal step and a type of liquid supplied to the second head chip as a part of the third liquid ejection head before the removal step. In this way, the adjustment process can be performed in accordance with the type of liquid supplied when the head chip is used in the liquid ejection head, and the difference in the ejection performance of the first and second head chips can be reduced as described above.

7. In the above-described configuration, the first liquid ejection head may be used in a liquid ejection operation of ejecting liquid in a state of being mounted on the liquid ejection apparatus. In this way, for example, the head chip of the liquid ejection head used in the liquid ejection apparatus such as the printer can be reused, which contributes to resource saving.

8. In the above-described configuration, in the assembly step, only a plurality of head chips including the first head chip and the second head chip may be incorporated into the second liquid ejection head, the plurality of head chips being removed from each of a plurality of liquid ejection heads that have a history of being used in an ejection operation of ejecting liquid in a state of being mounted on one or a plurality of liquid ejection apparatuses. In this manner, it is not necessary to use a newly manufactured head chip, and the burden on the environment can be reduced. It is more preferable that the plurality of head chips including the first head chip and the second head chip are selected to have the same degree of deterioration, and the difference in the ejection performance between the head chips is reduced by the above-described adjustment process.

9. In the above-described configuration, the removal step may include removing, from the first liquid ejection head including the first head chip of which a degree of deterioration belongs to a first rank and a third head chip of which a degree of deterioration belongs to a second rank higher than the first rank and a third liquid ejection head different from the second liquid ejection head, the second head chip belonging to the first rank, and in the assembly step, a plurality of head chips including the first head chip and the second head chip belonging to the first rank may be incorporated into the second liquid ejection head. In this way, since the second liquid ejection head can be configured by using the head chips belonging to the same rank, the aging process can be uniformly performed, and unnecessary deterioration of the head chip is not caused. Further, the aging process can be reduced. Further, as a result, the variation in the ejection performance of the second liquid ejection head can be reduced.

10. In the above-described configuration, in the adjustment step, a condition of the adjustment process may be set based on a use history of the first head chip. When the measurement is performed based on the use history, it is not necessary to measure the ejection performance. As a matter of course, the ejection performance of the first head chip may be measured, and the adjustment process may be performed based on the measurement value. In the latter case, it is not necessary to store the use history or the like in the memory or to read the use history or the like.

11. In the above-described configuration, in the removal step, among a plurality of head chips included in the first liquid ejection head, the head chip determined to be reusable based on a use history of the head chip may be removed as the first head chip. In this way, it is possible to prevent a situation in which the head chip that cannot be reused or has a low possibility of reuse is used, and the life of the assembled liquid ejection head is shortened in an unexpected manner. The head chip determined not to be reusable may be removed from the first liquid ejection head and then discarded, or the first liquid ejection head may be discarded after only the head chip, which is reusable, is removed.

12. In the above-described configuration, the second liquid ejection head may include a drive signal wiring for supplying a common drive signal to the actuators of the first head chip and the second head chip. In this manner, since the difference in the ejection performance between the first and second head chips is reduced by the adjustment process, the first and second head chips can be driven by the common drive signal supplied by the common drive signal wiring, and thus the simplification of the configuration of the liquid ejection head and the suppression of the variation in the ejection performance can be achieved at the same time.

13. In the above-described configuration, the second liquid ejection head may have a history of being used in an ejection operation of ejecting liquid in a state of being mounted on a liquid ejection apparatus, assembling the second liquid ejection head in the assembly step may be performed by incorporating the first head chip into the second liquid ejection head from which other head chips excluding at least one head chip remaining in the second liquid ejection head as the second head chip are removed, and in the adjustment step, the adjustment process may be performed on at least the second head chip. In this manner, the liquid ejection head can be manufactured as a repair of the existing liquid ejection head, instead of manufacturing a new liquid ejection head.

14. In each of the above-described embodiments, the liquid ejection apparatus 10 includes the head unit 3 including the plurality of liquid ejection heads 31, but the present disclosure is not limited thereto. The liquid ejection apparatus 10 may include one liquid ejection head 31, that is, need not include the head unit 3.

15. In each of the above-described embodiments, a selection step of selecting the used head chip to be incorporated into the second liquid ejection head 31x or the like may be performed based on the rank in which the plurality of used head chips 300 are classified based on the ranking in which the used head chips 300 are classified into a plurality of ranks based on the degree of deterioration of the piezoelectric element 60 without performing the second ranking C2 based on the initial characteristic value.

16. The use history of the used head chip 300 may be acquired by any of the following methods.
The use history of the used head chip 300 of the liquid ejection head 31 of the sales or lease destination (hereinafter, referred to as a customer) may be acquired via the network from the printer at the customer connected to the Internet in a state in which the printer can access the memory that stores the use history.
Data related to the use history may be stored in the memory of the substrate included in the printer at the customer. For example, the worker who collects the first liquid ejection head 31 may acquire the use history data by using an electronic device capable of reading and saving the data of the use history from the printer by being coupled to the printer at the customer, and may acquire the use history by transmitting the data to the server of the company that performs the reuse process RCL wirelessly or by wire from the electronic device.

17. In each of the above-described embodiments, the information on the use history may be the use history itself or may be information correlated with the use history. For example, the information on the reference voltage Vm of the drive waveform of the drive signal COM, which is an example of the use history, may be the reference voltage Vm itself, and the reference voltage Vm may be calculated from the intermediate potential Vc and the reference potential Vbs, so that the intermediate potential Vc of the drive signal COM and the reference potential Vbs of the reference voltage signal may be used.

18. In the above-described manufacturing method of a liquid ejection head, at least some of the following steps are carried out:
1. Manufacturing a new head chip (step X1);
2. Incorporating a newly manufactured head chip into a liquid ejection head (step X2);
3. For the head chip incorporated in the liquid ejection head, managing data related to the head chip characteristic information such as the initial characteristic value of the head chip with the assignment of a unique ID such as the serial number (step X3);
4. Collecting the used liquid ejection head with the use history from the market after the liquid ejection head is supplied to the market (step Y1);
5. Extracting the used head chip from the collected liquid ejection head (step Y2);
6. Managing the used head chip stored with the characteristic information in which the rank information is associated with the used head chip, together with the ranking of the used head chip performed by acquiring the characteristic information of the used head chip (step Y3);
7. Selecting ranked used head chip by taking the ranking into account, to manufacture a new liquid ejection head using the selected head chip (step Z1);
8. Manufacturing the liquid ejection head used together with the used head chip of a specific liquid ejection head using the selected head chip in which the used head chip is ranked based on the ranking (step Z2); and
9. Providing the used head chip rank-stored in response to the requests of the subjects Z1 and Z2 (step Z3).

The steps X1 to X3 correspond to the time until a new head chip is supplied to the market, the steps Y1 to Y3 correspond to the time until the used head chip is collected and managed, and the steps Z1 to Z3 are related to the manufacturing or repair of the liquid ejection head using the used head chip. The steps Y2 and Y3 may also be regarded as being related to the manufacturing or repair of the liquid ejection head using the used head chip. All of steps X1 to Z3 may be performed by the same subject such as a company, or steps X1 to X3, steps Y1 to Y3, and steps Z1 to Z3 may be performed by different subjects. As a matter of course, all the processes may be performed by different subjects.

In each of the above-described embodiments, a part of the configuration implemented by hardware may be replaced with software. At least a part of the configuration implemented by the software can also be implemented by a discrete circuit configuration. In addition, when a part or all of the functions of the present disclosure are implemented by software, the software (computer program) can be provided in a form stored in a computer-readable recording medium. The “computer-readable recording medium” is not limited to a portable recording medium such as a flexible disk or a CD-ROM, and includes an internal storage device in a computer such as various RAMs and ROMs and an external storage device fixed to the computer such as a hard disk. That is, the “computer-readable recording medium” has a broad meaning including any recording medium that can temporarily or fixedly store a data packet.

The present disclosure is not limited to the above-described embodiments, and can be implemented in various configurations without departing from the gist of the present disclosure. For example, the technical features in the embodiments corresponding to technical features in respective aspects described in SUMMARY of the present disclosure can be replaced or combined as appropriate in order to eliminate some or all of the above-described problems or to achieve some or all of the above-described effects. In addition, unless the technical features are described as being essential in the present specification, the technical features can be deleted as appropriate.

What is claimed is:

1. A manufacturing method of a liquid ejection head that is a method for reusing a first head chip of a first liquid ejection head to manufacture a second liquid ejection head including the first head chip and a second head chip different from a head chip incorporated in the first liquid ejection head, the first head chip and the second head chip each including an actuator that is driven for liquid ejection, the manufacturing method comprising:
a removal step of removing the first head chip from the first liquid ejection head;
an assembly step of incorporating the first head chip into the second liquid ejection head; and
an adjustment step of performing an adjustment process of reducing a difference between ejection performance of the first head chip and ejection performance of the second head chip, on the actuator of at least one of the first head chip or the second head chip.

2. The manufacturing method of a liquid ejection head according to claim 1, wherein
the removal step includes removing the second head chip from a third liquid ejection head different from the first liquid ejection head and the second liquid ejection head, and
the assembly step includes incorporating the second head chip into the second liquid ejection head.

3. The manufacturing method of a liquid ejection head according to claim 1, wherein
the actuator is a piezoelectric actuator, and
the adjustment process is an aging process of deteriorating the piezoelectric actuator of at least one of the first head chip or the second head chip.

4. The manufacturing method of a liquid ejection head according to claim 3, wherein
the removal step includes removing the second head chip from a third liquid ejection head different from the first liquid ejection head and the second liquid ejection head,
the assembly step includes incorporating the second head chip into the second liquid ejection head, and
the adjustment step includes setting a condition of the aging process performed on the at least one of the first head chip or the second head chip based on a reference voltage of a drive waveform applied to the piezoelectric actuator of the first head chip as a part of the first liquid ejection head before the removal step and a reference voltage of a drive waveform applied to the piezoelectric actuator of the second head chip as a part of the third liquid ejection head before the removal step.

5. The manufacturing method of a liquid ejection head according to claim 3, wherein
the removal step includes removing the second head chip from a third liquid ejection head different from the first liquid ejection head and the second liquid ejection head,
the assembly step includes incorporating the second head chip into the second liquid ejection head, and
the adjustment step includes setting a condition of the aging process performed on the at least one of the first head chip or the second head chip based on an environmental temperature when the first liquid ejection head is used before the removal step and an environmental temperature when the third liquid ejection head is used before the removal step.

6. The manufacturing method of a liquid ejection head according to claim 3, wherein
the removal step includes removing the second head chip from a third liquid ejection head different from the first liquid ejection head and the second liquid ejection head,
the assembly step includes incorporating the second head chip into the second liquid ejection head, and
the adjustment step includes setting a condition of the aging process performed on the at least one of the first head chip or the second head chip based on a type of liquid supplied to the first head chip as a part of the first liquid ejection head before the removal step and a type of liquid supplied to the second head chip as a part of the third liquid ejection head before the removal step.

7. The manufacturing method of a liquid ejection head according to claim 1, wherein
the first liquid ejection head has a history of being used in an ejection operation of ejecting liquid in a state of being mounted on a liquid ejection apparatus.

8. The manufacturing method of a liquid ejection head according to claim 1, wherein
in the assembly step, only a plurality of head chips including the first head chip and the second head chip are incorporated into the second liquid ejection head, the plurality of head chips being removed from each of a plurality of liquid ejection heads that have a history of being used in an ejection operation of ejecting liquid in a state of being mounted on one or a plurality of liquid ejection apparatuses.

9. The manufacturing method of a liquid ejection head according to claim 1, wherein
the removal step includes removing, from the first liquid ejection head including the first head chip of which a degree of deterioration belongs to a first rank and a third head chip of which a degree of deterioration belongs to a second rank higher than the first rank and a third liquid ejection head different from the second liquid ejection head, the second head chip belonging to the first rank, and
in the assembly step, a plurality of head chips including the first head chip and the second head chip belonging to the first rank are incorporated into the second liquid ejection head.

10. The manufacturing method of a liquid ejection head according to claim 1, wherein
in the adjustment step, a condition of the adjustment process is set based on a use history of the first head chip.

11. The manufacturing method of a liquid ejection head according to claim 1, wherein
in the removal step, among a plurality of head chips included in the first liquid ejection head, the head chip determined to be reusable based on a use history of the head chip is removed as the first head chip.

12. The manufacturing method of a liquid ejection head according to claim 1, wherein
the second liquid ejection head includes a drive signal wiring for supplying a common drive signal to the actuators of the first head chip and the second head chip.

13. The manufacturing method of a liquid ejection head according to claim 1, wherein
the second liquid ejection head has a history of being used in an ejection operation of ejecting liquid in a state of being mounted on a liquid ejection apparatus,
assembling the second liquid ejection head in the assembly step is performed by incorporating the first head chip into the second liquid ejection head from which other head chips excluding at least one head chip remaining in the second liquid ejection head as the second head chip are removed, and
in the adjustment step, the adjustment process is performed on at least the second head chip.
